(19) United States
(12) Patent Application Publication
(10) Pub. No.: US 2023/0402602 A1
(43) Pub. Date: Dec. 14, 2023

(54) POSITIVE ELECTRODE ACTIVE MATERIAL AND SECONDARY BATTERY

(71) Applicant: SEMICONDUCTOR ENERGY LABORATORY CO., LTD., Atsugi-shi (JP)

(72) Inventors: Shunpei YAMAZAKI, Tokyo (JP); Shotaro MURATSUBAKI, Atsugi (JP); Takayuki IKEDA, Atsugi (JP)

(21) Appl. No.: 18/327,948

(22) Filed: Jun. 2, 2023

(30) Foreign Application Priority Data
Jun. 8, 2022 (JP) 2022-092766
Jun. 17, 2022 (JP) 2022-098104
Sep. 2, 2022 (JP) 2022-139989

(51) Int. Cl. H01M 4/525; H01M 4/505; H01M 50/46; H01M 4/62; H01M 10/0525

(52) U.S. Cl. CPC H01M 4/525; H01M 4/505; H01M 50/46; H01M 4/625; H01M 10/0525; H01M 2004/028

(57) ABSTRACT

One embodiment of the present invention further improves thermal safety of a lithium-ion secondary battery for stable power supply from the lithium-ion secondary battery. To improve thermal safety, fluorine is contained in a positive electrode active material or adsorbed on a surface portion of the positive electrode active material so that overheating or ignition of the lithium-ion secondary battery is inhibited. When fluorine is adsorbed on the surface of the positive electrode active material, the adsorbed fluorine can react with its vicinity electrolyte solution or the like, leading to inhibition of thermal decomposition or the like of the electrolyte solution.

### BACKGROUND OF THE INVENTION

### 1. Field of the Invention

One embodiment of the present invention relates to an object, a method, or a manufacturing method. The present invention relates to a process, a machine, manufacture, or a composition of matter. One embodiment of the present invention relates to a power storage device including a secondary battery, a semiconductor device, a display device, a light-emitting device, a lighting device, an electronic device, or a manufacturing method thereof.

Note that electronic devices in this specification mean all devices including power storage devices, and electro-optical devices including power storage devices, information terminal devices including power storage devices, and the like are all electronic devices.

### 2. Description of the Related Art

In recent years, a variety of power storage devices such as lithium-ion secondary batteries, lithium-ion capacitors, air batteries, and all-solid-state batteries have been actively developed. In particular, demand for lithium-ion secondary batteries with high output and high capacity has rapidly grown with the development of the semiconductor industry. The lithium-ion secondary batteries are essential as rechargeable energy supply sources for today's information society.

In particular, secondary batteries for mobile electronic devices, for example, are highly demanded to have high discharge capacity per weight and excellent cycle performance. In order to meet such demands, positive electrode active materials in positive electrodes of secondary batteries have been actively improved (e.g., Patent Document 1).

Lithium-ion secondary batteries are known to enter thermal runaway after passing through several states when the temperature rises (Non-Patent Document 1).

### REFERENCES

### Patent Document

[Patent Document 1] Japanese Published Patent Application No. 2020-068210

### Non-Patent Document

[Non-Patent Document 1] Nobuo Eda, “2-4: Mechanism of Heat Generation” in “Learning Charging and Discharging Techniques of Li-Ion Batteries from Data” [Translated from Japanese.], CQ Publishing Co., Ltd., published on Apr. 4, 2020, pp. 68-72.

### SUMMARY OF THE INVENTION

Lithium-ion secondary batteries can be used in next-generation clean energy vehicles typified by hybrid vehicles (HVs), electric vehicles (EVs), and plug-in hybrid vehicles (PHVs). The secondary batteries can be mounted not only on next-generation clean energy vehicles but also on transport vehicles such as agricultural machines, motorized bicycles including motor-assisted bicycles, motorcycles, electric wheelchairs, electric carts, boats and ships, submarines, aircraft typified by fixed-wing aircraft and rotary-wing aircraft, rockets, artificial satellites, space probes, planetary probes, and spacecraft.

Lithium-ion secondary batteries used for a variety of applications as described above have been subjected to safety verification assuming a variety of situations. For example, nail penetration tests and the like have been conducted assuming internal short circuits in secondary batteries. Internal short circuits in secondary batteries might cause heat generation and battery ignition.

Lithium-ion secondary batteries have been required to have further improved thermal safety to stably supply power.

To improve thermal safety, fluorine is contained in a surface portion of a positive electrode active material or adsorbed on a surface of the positive electrode active material so that overheating or ignition of a lithium-ion secondary battery is inhibited.

The positive electrode active material contains a transition metal M and oxygen. The transition metal M contains nickel, manganese, and cobalt. Such a positive electrode active material is referred to as NCM. NCM has a layered rock-salt crystal structure. NCM can have an improved energy density when the nickel content is increased.

Fluorine may be dissolved in the positive electrode active material. For example, part of oxygen in the crystal structure of NCM may be substituted by fluorine. It is known that fluorine has high electronegativity and is likely to form stable compounds with many kinds of element.

One embodiment of the invention disclosed in this specification is a positive electrode active material in which fluorine is adsorbed on a surface. Specifically, a fluoro group is adsorbed on the surface of the positive electrode active material; thus, the adsorbed fluoro group can react with an electrolyte solution or the like near the fluoro group, leading to inhibition of thermal decomposition or the like of the electrolyte solution. When fluorine can be detected by X-ray photoelectron spectroscopy (XPS), for example, using a measurement instrument for measuring the element concentration in the positive electrode active material while the fluorine adsorbed on the surface is regarded to be contained in the positive electrode active material, the positive electrode active material can be regarded to contain fluorine. Note that fluorine on a particle surface or inside the particle can be detected by using time-of-flight secondary ion mass spectrometry (TOF-SIMS) instead of XPS. Analysis results of energy dispersive X-ray spectroscopy (EDX), gas chromatography mass spectroscopy (GC/MS), pyrolysis gas chromatography mass spectroscopy (Py-GC/MS), liquid chromatography mass spectroscopy (LC/MS), or the like can also be used for judging whether fluorine is contained or not.

One embodiment of the invention disclosed in this specification is a positive electrode active material containing a transition metal M, oxygen, and fluorine. The transition metal M contains nickel, manganese, and cobalt. The positive electrode active material has a surface portion and an inner portion. A surface of the surface portion contains fluorine. The surface portion has a higher magnesium concentration than the inner portion.

A secondary battery including the positive electrode active material is also one embodiment of the present invention. Specifically, one embodiment of the present invention is a secondary battery including a positive electrode, a negative electrode, a separator between the positive electrode and the negative electrode, and an ionic liquid or an organic solvent between the positive electrode and the negative electrode. The positive electrode contains a positive electrode active material and a conductive material. The positive electrode active material contains a transition metal M, oxygen, and fluorine. The transition metal M contains nickel, manganese, and cobalt. The positive electrode active material has a surface portion and an inner portion. The surface portion has a higher magnesium concentration than the inner portion. A surface of the surface portion contains fluorine.

In the above structure, fluorine may be adsorbed on a surface of the conductive material.

In the above structure, the conductive material may be any carbon material, specifically, a carbon nanotube or acetylene black.

Another embodiment of the present invention is a formation method of the positive electrode active material. In the formation method, a positive electrode active material containing nickel, manganese, and cobalt is formed and then a mixture of the positive electrode active material and a fluoride is put in a container, and heating is performed while the container is covered with a lid, so that fluorine is adsorbed on a surface of the positive electrode active material. The heating is preferably performed under pressure.

Putting the mixture of the positive electrode active material and a fluoride in a container followed by heating while the container is covered with a lid may be performed a plurality of times in order that fluorine can be adsorbed on the surface of the positive electrode active material. Repeated addition of fluorine can increase the concentration of fluorine on the surface of the positive electrode active material. An increase in the concentration of fluorine on the surface of the positive electrode active material can inhibit thermal decomposition or the like of an electrolyte solution more effectively.

In the above structure, the surface portion of the positive electrode active material contains magnesium and the surface portion has a higher magnesium concentration than the inner portion. An appropriate concentration of magnesium in lithium sites of the surface portion facilitates maintenance of a layered rock-salt crystal structure of the inner portion. This is probably because magnesium in the lithium sites serves as a column supporting MO₂ layers. Thus, the surface portion containing magnesium can improve the structure stability of the positive electrode active material.

An appropriate magnesium concentration can bring the above advantage without an adverse effect on insertion and extraction of lithium in charging and discharging. Meanwhile, excess magnesium might adversely affect insertion and extraction of lithium and might reduce the effect of stabilizing the crystal structure. Moreover, an undesired magnesium compound (e.g., an oxide or a fluoride) which is substituted for neither the lithium site nor the transition metal M site might segregate at the surface of the positive electrode active material or the like to serve as a resistance component of the secondary battery. As the magnesium concentration in the positive electrode active material increases, the discharge capacity of the positive electrode active material decreases in some cases. This is probably because excess magnesium enters the lithium sites and the amount of lithium contributing to charging and discharging decreases.

The surface portion containing fluorine and magnesium can inhibit overheating or ignition of the lithium-ion secondary battery and can further improve thermal safety.

Note that it is not preferable that the surface portion be occupied by only a compound of an additive element (magnesium or aluminum) and oxygen because it becomes difficult to insert and extract lithium. For example, it is not preferable that the surface portion be occupied by only magnesium oxide and a structure in which magnesium oxide and an oxide of a divalent transition metal M form a solid solution. Thus, the surface portion needs to contain at least the transition metal M, and also contain cobalt or lithium in a discharged state to have a path through which lithium is inserted and extracted.

A region containing magnesium or fluorine may have an island shape. The positive electrode active material can function as a positive electrode active material even when part of the inner portion is exposed due to insufficient covering by the surface portion. The island-shaped surface portion can have higher energy density than the inner portion.

To ensure a sufficient path through which lithium is inserted and extracted, the total number of atoms of the transition metal M is preferably larger than the total number of atoms of the additive element, in other words, the concentration of the transition metal M is preferably high, in the surface portion.

An additive element may be added to the positive electrode active material. The additive element is one or more selected from aluminum, calcium, titanium, chromium, and zirconium.

An oxide of titanium, which is an example of the additive element, is known to have superhydrophilicity. Accordingly, the positive electrode active material containing an oxide of titanium at the surface portion presumably has good wettability with respect to a high-polarity solvent. Such a positive electrode active material and a high-polarity electrolyte solution can have favorable contact at the interface therebetween and presumably inhibit an internal resistance increase when a secondary battery is formed using such a positive electrode active material.

A barrier film may be provided to cover a positive electrode active material and the barrier film may function as part of the positive electrode active material.

The positive electrode active material contains a transition metal M and oxygen. The transition metal M contain nickel, manganese, and cobalt. Such a positive electrode active material is referred to as NCM. NCM has a layered rock-salt crystal structure. NCM can have an improved energy density when the nickel content is increased.

The barrier film contains at least magnesium and cobalt and has a layered rock-salt crystal structure. The barrier film functions as part of the positive electrode active material and thus can be referred to as a surface portion.

When fluorine is adsorbed on a surface of the barrier film, overheating or ignition of the lithium-ion secondary battery is inhibited and thermal safety is improved.

Fluorine may be dissolved in the barrier film, which is part of the positive electrode active material. For example, part of oxygen in the crystal structure of NCM may be substituted by fluorine. It is known that fluorine has high electronegativity and is likely to form stable compounds with many kinds of element.

Another embodiment of the present invention is a formation method of the positive electrode active material. In the formation method, a positive electrode active material containing nickel, manganese, and cobalt is formed and then the positive electrode active material and a mixture of a cobalt compound and a fluoride (magnesium fluoride) are put in a container, and heating is performed while the container is covered with a lid, so that fluorine is adsorbed on a surface of the positive electrode active material. The heating is preferably performed under pressure.

According to one embodiment of the present invention, a positive electrode active material that is less likely to deteriorate can be provided. A novel positive electrode active material can be provided. A highly safe or highly reliable secondary battery can be provided. A lithium-ion secondary battery with a long lifetime can be provided.

According to one embodiment of the present invention, overheating or ignition of a lithium-ion secondary battery can be inhibited and thermal safety can be improved.

Note that the description of these effects does not preclude the existence of other effects. One embodiment of the present invention does not need to have all the effects. Other effects will be apparent from and can be derived from the description of the specification, the drawings, the claims, and the like.

### BRIEF DESCRIPTION OF THE DRAWINGS

FIG. 1A is a schematic cross-sectional view of a positive electrode active material. FIG. 1B is an enlarged view of part of FIG. 1A. FIG. 1C is a schematic cross-sectional view of another positive electrode active material.

FIGS. 2A and 2B each illustrate a formation method of a positive electrode active material.

FIG. 3 is a cross-sectional view illustrating an example of a formation step of one embodiment of the present invention.

FIG. 4 shows a formation method of a positive electrode active material.

FIG. 5 shows a formation method of a positive electrode active material.

FIG. 6A to FIG. 6D are each a schematic cross-sectional view of a positive electrode.

FIG. 7A is an exploded perspective view of a coin-type secondary battery.

FIG. 7B is a perspective view of the coin-type secondary battery. FIG. 7C is a cross-sectional perspective view of the coin-type secondary battery.

FIGS. 8A and 8B each illustrate an example of a cylindrical secondary battery.

FIG. 8C illustrates an example of a plurality of cylindrical secondary batteries. FIG. 8D illustrates an example of a power storage system including a plurality of cylindrical secondary batteries.

FIGS. 9A and 9B each illustrate an example of a secondary battery. FIG. 9C illustrates an inner state of the secondary battery.

FIGS. 10A to 10C illustrate an example of a secondary battery.

FIGS. 11A and 11B each illustrate the appearance of a secondary battery.

FIGS. 12A to 12C illustrate a fabrication method of a secondary battery.

FIG. 13A is a perspective view of a battery pack of one embodiment of the present invention. FIG. 13B is a block diagram of the battery pack. FIG. 13C is a block diagram of a vehicle including the battery pack.

FIGS. 14A to 14D illustrate examples of transport vehicles. FIG. 14E illustrates an example of an artificial satellite.

FIG. 15A illustrates an electric bicycle. FIG. 15B illustrate a secondary battery of the electric bicycle. FIG. 15C illustrates a motor scooter.

FIGS. 16A to 16D illustrate examples of electronic devices.

FIG. 17 is a graph showing a temperature rise in a secondary battery.

FIG. 18A illustrates a nail penetration test. FIG. 18B is an enlarged view of a positive electrode active material.

FIG. 19 is a graph showing a temperature rise in a secondary battery when an internal short-circuit occurs.

FIG. 20 illustrates crystal planes of a positive electrode active material.

FIGS. 21A and 21B are each a schematic cross-sectional view of a positive electrode active material. FIG. 21C is an enlarged view of part of FIG. 21B.

FIGS. 22A and 22B each show a formation method of a positive electrode active material.

FIG. 23 shows a formation method of a positive electrode active material.

FIGS. 24A to 24D are each schematic cross-sectional view of a positive electrode.

### DETAILED DESCRIPTION OF THE INVENTION

Hereinafter, embodiments of the present invention will be described in detail with reference to the drawings. Note that the present invention is not limited to the description below, and it is easily understood by those skilled in the art that modes and details of the present invention can be modified in various ways. In addition, the present invention should not be construed as being limited to the description in the following embodiments.

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

Uniformity refers to a state in which, in a solid made of a plurality of elements (e.g., A, B, and C), a certain element (e.g., A) is distributed with similar nature in specific regions. Note that it is acceptable for the specific regions to have substantially the same concentration of the element. For example, a difference in the detected amount of the certain element (e.g., the count number obtained by a scanning transmission electron microscope-energy dispersive X-ray analysis, STEM-EDX) between the specific regions needs to be 10% or less. Examples of the specific regions include a surface portion, a surface, a projection, a depression, and an inner portion.

A positive electrode active material to which an additive element is added is sometimes referred to as a composite oxide, a positive electrode member, a positive electrode material, a secondary battery positive electrode member, or the like. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a complex.

In the case where the features of individual particles of a positive electrode active material are described in the following embodiment and the like, not all the particles necessarily have the features. When 50% or more, preferably 70% or more, further preferably 90% or more of three or more randomly selected particles of a positive electrode active material have the features, for example, it can be said that an effect of improving the characteristics of the positive electrode active material and a secondary battery including the positive electrode active material is sufficiently obtained.

A short circuit of a secondary battery might cause not only a malfunction in charging operation and/or discharging operation of the secondary battery but also heat generation and ignition. In order to obtain a safe secondary battery, short-circuit current is preferably inhibited even at a high charge voltage. With the positive electrode active material of one embodiment of the present invention, short-circuit current is inhibited even at a high charge voltage. Thus, a secondary battery with both high discharge capacity and high safety can be obtained.

The description is made on the assumption that materials (such as a positive electrode active material, a negative electrode active material, an electrolyte, and a separator) of a secondary battery have not deteriorated unless otherwise specified. A decrease in discharge capacity due to aging treatment (also referred to as burn-in treatment) during the fabrication process of a secondary battery is not regarded as deterioration. For example, a state where discharge capacity is higher than or equal to 97% of the rated capacity of a lithium-ion secondary battery cell and an assembled lithium-ion secondary battery (hereinafter, referred to as a lithium-ion secondary battery) can be regarded as a non-deteriorated state. The rated capacity conforms to Japanese Industrial Standards (JIS C 8711:2019) in the case of a lithium-ion secondary battery for a portable device. The rated capacities of other lithium-ion secondary batteries conform to not only JIS described above but also JIS, standards defined by the International Electrotechnical Commission (IEC), and the like for electric vehicle propulsion, industrial use, and the like.

In some cases, materials included in a secondary battery that have not been degraded are referred to as initial products or materials in an initial state, and materials that have been degraded (have discharge capacity lower than 97% of the rated capacity of the secondary battery) are referred to as products in use, materials in a used state, products that are already used, or materials in an already-used state.

### Embodiment 1

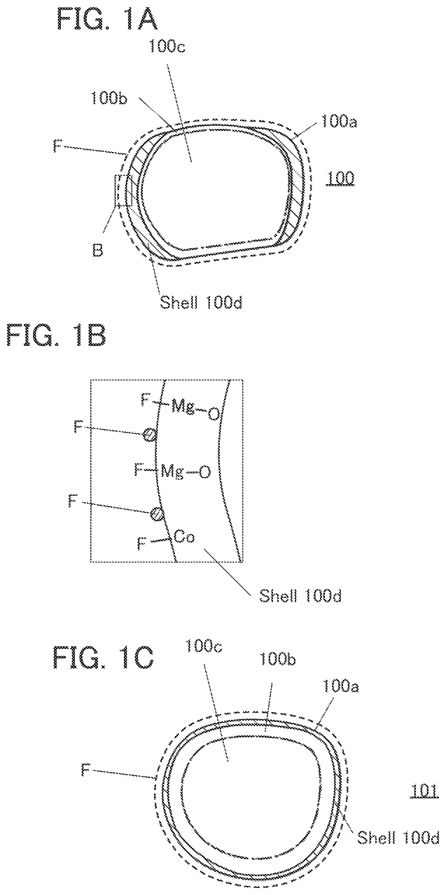

In this embodiment, a positive electrode active material 100 of one embodiment of the present invention will be described with reference to FIGS. 1A and 1B.

The positive electrode active material 100 contains lithium, a transition metal M, oxygen, and fluorine. The transition metal M is one or two or more selected from nickel, manganese, and cobalt. The positive electrode active material 100 preferably contains an additive element in addition to the transition metal M. The positive electrode active material 100 can contain lithium nickel-manganese-cobalt oxide to which an additive element is added.

A positive electrode active material of a lithium-ion secondary battery needs to contain a transition metal which can take part in an oxidation-reduction reaction in order to maintain a neutrally charged state even when lithium ions are inserted and extracted. The positive electrode active material 100 of one embodiment of the present invention contains nickel, manganese, and cobalt as the transition metal M taking part in an oxidation-reduction reaction.

Nickel preferably accounts for a large percentage of the transition metal M contained in the positive electrode active material 100 because it is easier to increase the charge and discharge capacity than in the case where cobalt accounts for more than half, even when charge voltage is low. Thus, nickel preferably accounts for 50% or more of the transition metal M contained in the positive electrode active material 100, further preferably 60% or more, still further preferably 75% or more, for example. The positive electrode active material 100 contains fluorine, and a Ni—Co—Mn-based positive electrode active material (also referred to as NCM) whose composition excluding fluorine is represented by LiNiₓCo_{y}Mn_{z}O₂ (x>0, y>0, and z>0) is used as the positive electrode active material 100. Note that x, y, and z preferably satisfy x:y:z=5:2:3 or the neighborhood thereof, or x:y:z=6:2:2 or the neighborhood thereof, for example. Alternatively, for example, x, y, and z preferably satisfy x:y:z=8:1:1 or the neighborhood thereof. Alternatively, for example, x, y, and z preferably satisfy x:y:z=9:0.5:0.5 or the neighborhood thereof.

An additive element may be added to the positive electrode active material 100. For example, one or more selected from magnesium, aluminum, calcium, titanium, zirconium, fluorine, vanadium, iron, manganese, chromium, niobium, arsenic, zinc, silicon, sulfur, phosphorus, boron, bromine, and beryllium may be used as the additive element. The ratio of the number of atoms of the additive element to the total number of atoms of the transition metal M is preferably lower than 25 atomic %, further preferably lower than 10 atomic %, still further preferably lower than 5 atomic %. In the case where a transition metal (e.g., titanium) is added as the additive element, the additive element is not included in the transition metal M.

Such an additive element further stabilizes the crystal structure of the positive electrode active material 100 as described later. In this specification and the like, an additive element can be rephrased as part of a raw material or a mixture.

A surface portion 100b preferably has a higher fluorine concentration than an inner portion 100c. The inner portion 100c preferably has a higher nickel concentration than the surface portion. The concentration of fluorine preferably has a gradient that increases from the inner portion toward the surface. An additive element, e.g., magnesium, may be added to the surface portion 100b so that the surface portion 100b can function as a barrier layer. In the case of using magnesium, magnesium fluoride and NCM are mixed and heated so that the concentrations of magnesium and fluorine in the surface portion 100b can be higher than those in the inner portion 100c.

The surface portion 100b containing fluorine and magnesium can inhibit overheating or ignition of the lithium-ion secondary battery and can further improve thermal safety.

### <Surface and Surface Portion>

FIG. 1A is a cross-sectional view of the positive electrode active material 100 which is a single particle. The positive electrode active material 100 preferably includes a surface portion and the inner portion 100c.

The positive electrode active material 100 of one embodiment of the present invention preferably has a region whose resistance can be increased. Such a region is referred to as a first region, in some cases, to be distinguished from other regions. The first region preferably has, in a cross-sectional view, a narrow width of greater than or equal to 2 nm and less than or equal to 20 nm, further preferably greater than or equal to 2 nm and less than or equal to 10 nm, still further preferably greater than or equal to 2 nm and less than or equal to 5 nm. Such a region having a narrow width is referred to as a “shell” in this specification and the like, in some cases. FIG. 1A illustrates an example in which a shell 100d exists on an end portion of the particle. The positive electrode active material 100 including such a shell 100d is preferred because the speed of current flowing into the positive electrode active material can be reduced even when the secondary battery is subjected to a nail penetration test, and ignition, smoke, or the like can be inhibited. The shell 100d is preferably positioned on the outer side of the surface portion of the positive electrode active material 100 so as to reduce the speed of current flowing into the positive electrode active material.

The shell 100d preferably contains cobalt, in which case the shell 100d allows insertion and extraction of lithium ions (Li⁺) and a reduction in speed of current that flows because of an internal short-circuit. The positive electrode active material 100 preferably has the first region and a second region which is at a position deeper than the first region; magnesium is preferably contained at least in the first region, and the second region does not necessarily contain magnesium. Cobalt contained in the first region and the second region probably allows insertion and extraction of lithium ions (Li⁺).

FIG. 1B is an enlarged conceptual diagram of a region B indicated by a rectangle in FIG. 1A. As illustrated in FIG. 1B, fluorine, which is an additive element, is preferably adsorbed on a surface 100a of the positive electrode active material. Fluorine has high electronegativity and is likely to form stable compounds with many kinds of element.

FIG. 1B illustrates a state where at least fluorine is adsorbed on the shell 100d of the positive electrode active material 100. Note that the surface 100a corresponds to part of the outermost region of the surface portion 100b in some cases and to part of the outermost region of the shell 100d in other cases. Fluorine does not need to be inside the shell 100d nor inside the surface portion 100b as long as the adsorbed fluorine efficiently contributes to inhibition of overheating or ignition of the lithium-ion secondary battery and further improvement in thermal safety.

The shell 100d or the adsorbed fluorine makes release of oxygen in the positive electrode active material 100 difficult and can inhibit a thermal decomposition reaction. The use of the positive electrode active material 100 including the shell 100d for a positive electrode can inhibit overheating or ignition of the lithium-ion secondary battery and can improve thermal safety.

Note that adsorption may be chemical adsorption or physical adsorption. Chemical adsorption refers to formation of a chemical bond due to a chemical reaction between at least one of additive elements and the surface 100a of the positive electrode active material, whereas physical adsorption refers to adsorption due to intermolecular force (van der Waals force) exerted between at least one of additive elements and the surface of the positive electrode active material 100. As is described later, fluorine may be substituted for part of oxygen in the positive electrode active material 100. Sufficient fluorine contained in the positive electrode active material 100 means that there are fluorine adsorbed on the surface and fluorine substituted for part of oxygen.

Examples of a fluoride contained in the lithium-ion secondary battery include, as described later, LiPF₆ and LiBF₄ as lithium salts and polyvinylidene fluoride (PVDF) as a binder. Fluorine originating from such a fluoride may be adsorbed on the surface 100a of the positive electrode active material.

The surface portion 100b of the positive electrode active material 100 in FIG. 1A is, for example, a region within 50 nm, preferably 35 nm, and further preferably 20 nm in depth from a surface where the surface portion is exposed toward the inner portion, and is most preferably within 10 nm in depth, in a direction perpendicular or substantially perpendicular to the surface, from a surface where the surface portion is exposed toward the inner portion. Note that “substantially perpendicular” refers to a state where an angle is greater than or equal to 80° and less than or equal to 100°. A plane generated by a crack can be considered as a surface. The outline of the surface can be seen when the cross section of the surface is observed.

FIG. 1A illustrates an example in which a specific region of the shell 100d has a large thickness. The specific region is, in the case where NCM is used for the positive electrode active material 100, for example, a plane other than the (001) plane of NCM. In other words, the shell 100d can be at any position of the positive electrode active material 100 as long as ignition does not occur in a nail penetration test. Magnesium may be present in the entire surface portion as long as lithium ions (Li⁺) can be inserted and extracted and the speed of current that flows because of an internal short-circuit can be reduced.

The shell 100d preferably has a narrow width (short range). Furthermore, the width of the shell 100d is preferably larger on a plane through which lithium can be inserted and extracted, that is, a plane other than the (001) plane, than on the (001) plane. In addition, the shell 100d preferably has a structure in which a region containing magnesium and a region containing nickel overlap with each other, connected to each other, or combined with each other on the plane through which lithium can be inserted and extracted, that is, the plane other than the (001) plane. This structure makes it possible to inhibit release of oxygen from the positive electrode active material or a structural change of the positive electrode active material. In other words, when the shell 100d is provided on the plane other than the (001) plane, release of oxygen from the plane other than the (001) plane can be inhibit in some cases. The (001) plane, the (003) plane, and the like are sometimes collectively referred to as the (00l) plane. The (00l) plane is sometimes referred to as a C-plane, a basal plane, or the like. Furthermore, NCM has a two-dimensional diffusion path of lithium. In other words, the diffusion path of lithium extends along a plane. In this specification and the like, a plane where the diffusion path of lithium is exposed or a plane through which lithium is inserted and extracted, i.e., a plane other than the (001) plane, is sometimes referred to as an edge plane. FIG. 1A illustrates a structure in which the shell 100d is selectively provided on the edge plane, not on the basal plane.

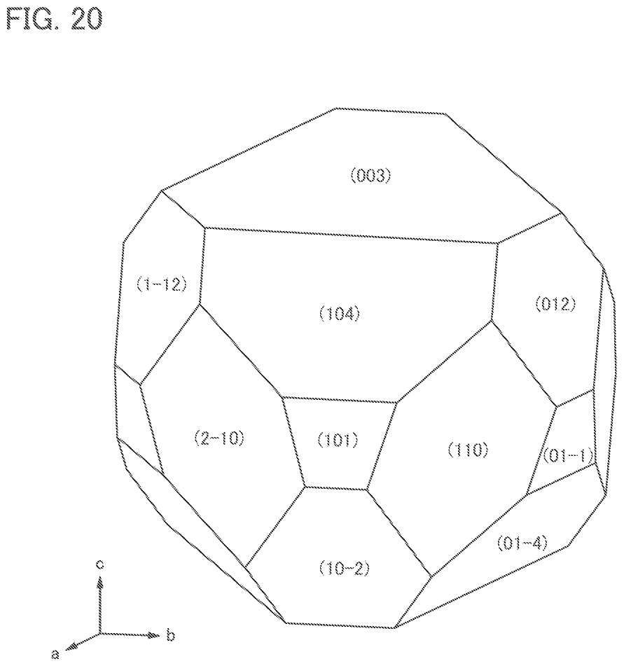

The surface portion 100b has a crystal structure of LiMeO₂ belonging to the space group R-3m. FIG. 20 illustrates the (003) plane, the (104) plane, the (012) plane, the (1-12) plane, the (101) plane, the (110) plane, the (2-10) plane, the (01-1) plane, the (10-2) plane, and the (01-4) plane as the planes of the LiMeO₂ crystal structure. Examples of a surface having an orientation other than the (001) orientation include the (104) plane, the (012) plane, the (1-12) plane, the (101) plane, the (110) plane, the (2-10) plane, the (01-1) plane, the (10-2) plane, the (01-4) plane, and planes parallel to these planes. The amount of an additive element detected from the surface having an orientation other than the (001) orientation and a surface portion of the surface is smaller than the amount of the additive element detected from a surface having the (001) orientation in some cases.

The surface portion 100b having the LiMeO₂ crystal structure has a two-dimensional diffusion path of lithium. In other words, the diffusion path of lithium extends along a plane. In this specification and the like, a plane where the diffusion path of lithium is exposed or a plane through which lithium is inserted and extracted, i.e., a plane other than the (001) plane, is sometimes referred to as an edge plane.

The positive electrode active material 100 contains at least nickel, manganese, and cobalt. Since nickel is contained, the positive electrode active material 100 preferably has a structure in which a region containing magnesium and a region containing nickel overlap with each other, connected to each other, or combined with each other on the plane through which lithium can be inserted and extracted, that is, the surface having an orientation other than the (001) orientation. This structure makes it possible to inhibit release of oxygen from the positive electrode active material or a structural change of the positive electrode active material. As illustrated in FIG. 1B, magnesium (Mg) is preferably bonded to oxygen in the shell 100d. Furthermore, the shell 100d preferably contains cobalt (Co), and Co is preferably bonded to oxygen. It is presumed that the shell 100d allows insertion and extraction of lithium ions (Li⁺) and a reduction in current that flows because of an internal short-circuit.

The inner portion 100c refers to a region deeper than the surface portion 100b of the positive electrode active material. The inner portion 100c can be rephrased as an inner region or a core.

The surface 100a of the positive electrode active material refers to a surface of a composite oxide that includes the surface portion 100b and the inner portion 100c. Thus, the positive electrode active material 100 does not contain a material to which a metal oxide that does not contain a lithium site contributing to charging and discharging, such as aluminum oxide (Al₂O₃), is attached, or a carbonate, a hydroxy group, or the like which is chemically adsorbed after formation of the positive electrode active material. The attached metal oxide refers to, for example, a metal oxide having a crystal structure different from the crystal structures of the inner portion 100c and the surface portion 100b.

Since the positive electrode active material 100 is a compound containing oxygen and a transition metal into and from which lithium can be inserted and extracted, an interface between a region where oxygen and the transition metal M(Co, Ni, Mn, Fe, or the like) that is oxidized or reduced due to insertion and extraction of lithium exist and a region where oxygen and the transition metal M do not exist is considered as the surface 100a of the positive electrode active material. When the positive electrode active material is analyzed, a protective film is attached on its surface in some cases; however, the protective film is not included in the positive electrode active material. As the protective film, a single-layer film or a multilayer film of carbon, a metal, an oxide, a resin, or the like is sometimes used.

Therefore, the position of the surface of the positive electrode active material in, for example, STEM-EDX line analysis refers to a point where the detected amount of the characteristic X-ray of the transition metal M is equal to 50% of the sum of the average value M_{AVE} of the detected amounts of the characteristic X-ray of the transition metal M in the inner portion and the average value M_{BG} of the detected amounts of the characteristic X-ray of the transition metal M of the background or a point where the detected amount of the characteristic X-ray of oxygen is equal to 50% of the sum of the average value O_{AVE} of the detected amounts of the characteristic X-ray of oxygen in the inner portion and the average value O_{BG} of the detected amounts of the characteristic X-ray of oxygen of the background. Note that when the position of the point where the detected amount of the characteristic X-ray of the transition metal M is equal to 50% of the sum of the average value of the detected amounts of the characteristic X-ray of the transition metal Min the inner portion and the average value of the detected amounts of the characteristic X-ray of the transition metal M of the background is different from the position of the point where the detected amount of the characteristic X-ray of oxygen is equal to 50% of the sum of the average value of the detected amounts of the characteristic X-ray of oxygen in the inner portion and the average value of the detected amounts of the characteristic X-ray of oxygen of the background, the difference is probably due to the influence of a carbonate, a metal oxide containing oxygen, or the like, which is attached to the surface. Thus, in such a case, the point where the detected amount of the characteristic X-ray of the transition metal M is equal to 50% of the sum of the average value M_{AVE} of the detected amounts of the characteristic X-ray of the transition metal M in the inner portion and the average value M_{BG} of the detected amounts of the characteristic X-ray of the transition metal M of the background can be employed as the position of the surface of the positive electrode active material. In the case of a positive electrode active material containing a plurality of the transition metals M, the position of its surface can be determined using M_{AVE} and M_{BG} of the element whose detected amount of the characteristic X-ray in the inner portion is larger than that of any other element.

The average value M_{BG} of the detected amounts of the characteristic X-ray of the transition metal M of the background can be calculated by averaging the detected amounts in the range greater than or equal to 2 nm, preferably greater than or equal to 3 nm, which is outside a portion in the vicinity of the portion at which the detected amount of the characteristic X-ray of the transition metal M begins to increase, for example. The average value M_{AVE} of the detected amounts of the characteristic X-ray of the transition metal Min the inner portion can be calculated by averaging the detected amounts in the range greater than or equal to 2 nm, preferably greater than or equal to 3 nm in a portion that is at a depth larger than, by greater than or equal to 30 nm, preferably greater than 50 nm, the depth at which the detected amounts of the characteristic X-ray of the transition metal M and oxygen are saturated and stabilized, e.g., the depth at which the detected amount of the characteristic X-ray of the transition metal M begins to increase. The average value O_{BG} of the detected amounts of the characteristic X-ray of oxygen of the background and the average value O_{AVE} of the detected amounts of the characteristic X-ray of oxygen in the inner portion can be calculated in a similar manner.

The surface 100a of the positive electrode active material in, for example, a cross-sectional STEM image is a boundary between a region where an image derived from the crystal structure of the positive electrode active material is observed and a region where the image is not observed. The surface of the positive electrode active material is also determined as the outermost surface of a region where an atomic column derived from an atomic nucleus of, among metal elements which constitute the positive electrode active material, a metal element that has a larger atomic number than lithium is observed in the cross-sectional STEM image. Alternatively, the surface refers to an intersection of a tangent drawn at a luminance profile from the surface toward the bulk and an axis in the depth direction in a STEM image. The surface in a STEM image or the like may be judged employing also analysis with higher spatial resolution.

The spatial resolution of STEM-EDX is approximately 1 nm. Thus, the maximum value of an additive element profile may be shifted by approximately 1 nm. For example, even when the maximum value of the profile of an additive element such as magnesium exists outside the surface determined in the above-described manner, it can be said that a difference between the maximum value and the surface is within the margin of error when the difference is less than 1 nm.

A peak in STEM-EDX linear analysis refers to the detection intensity in each element profile or the maximum value of the characteristic X-ray of each element. As a noise in STEM-EDX linear analysis, a measured value having a half width smaller than or equal to spatial resolution (R), for example, smaller than or equal to R/2 can be given.

The adverse effect of a noise can be reduced by scanning the same portion a plurality of times under the same conditions. For example, an integrated value obtained by performing scanning six times can be used as the profile of each element. The times of scanning is not limited to six and an average of measured values obtained by performing scanning seven or more times can be used as the profile of each element.

STEM-EDX linear analysis can be performed as follows. First, a protective film is deposited over a surface of a positive electrode active material. For example, carbon can be deposited with an ion sputtering apparatus (MC1000, produced by Hitachi High-Tech Corporation).

Next, the positive electrode active material is thinned to fabricate a cross-section sample to be subjected to STEM-EDX linear analysis. For example, the positive electrode active material can be thinned with an FIB-SEM apparatus (XVision 200TBS, produced by Hitachi High-Tech Corporation). Here, picking up can be performed by a micro probing system (MPS), and an accelerating voltage at final processing can be, for example, 10 kV.

The STEM-EDX linear analysis can be performed using HD-2700 produced by Hitachi High-Tech Corporation as a STEM apparatus and two Octane T Ultra W produced by EDAX Inc as EDX detectors. In the EDX linear analysis, the emission current of the STEM apparatus is set to be in the range of 6 μA to 10 μA, and a portion of the thinned sample, which is not positioned at a deep level and has little unevenness, is measured. The magnification is 150,000 times, for example. The EDX linear analysis can be performed under conditions where drift correction is performed, the line width is 42 nm, the pitch is 0.2 nm, and the number of frames is 6 or more.

### <Concentration Gradient>

The concentration of at least one of cobalt and manganese in the transition metal M is preferably higher in the surface portion 100b of the positive electrode active material than in the inner portion 100c. Furthermore, the concentration of nickel is preferably higher in the inner portion 100c than in the surface portion. The concentration of at least one of cobalt and manganese preferably has a gradient that increases toward the surface of the positive electrode active material 100. Furthermore, the concentration of nickel preferably has a gradient that increases toward the inner portion of the positive electrode active material 100.

It is further preferable that additive elements contained in the positive electrode active material 100 be differently distributed. For example, it is preferable that the additive elements exhibit concentration peaks at different depths from a surface. The concentration peak here refers to the local maximum value of the concentration in the surface portion 100b or the concentration in 200 nm or less in depth from the surface 100a.

It is preferable that the crystal structure continuously change from the inner portion toward the surface owing to the above-described concentration gradient of the additive element. Alternatively, it is preferable that the orientations of crystal structure of the surface portion and crystal structure of the inner portion 100c be substantially aligned with each other.

For example, the crystal structure preferably changes continuously from the inner portion 100c that has a layered rock-salt crystal structure toward the surface and the surface portion that have a feature of a rock-salt crystal structure or features of both a rock-salt crystal structure and a layered rock-salt crystal structure. Alternatively, the orientations of the surface portion that has the feature of a rock-salt crystal structure or the features of both a rock-salt crystal structure and a layered rock-salt crystal structure and the layered rock-salt inner portion 100c are preferably substantially aligned with each other.

Note that in this specification and the like, a layered rock-salt crystal structure, which belongs to the space group R-3m, of a composite oxide containing lithium and the transition metal M refers to a crystal structure in which a rock-salt ion arrangement where cations and anions are alternately arranged is included and lithium and the transition metal are regularly arranged to form a two-dimensional plane, so that lithium can diffuse two-dimensionally. Note that a defect such as a cation or anion vacancy may exist. In the layered rock-salt crystal structure, strictly, a lattice of a rock-salt crystal is distorted in some cases.

A rock-salt crystal structure refers to a structure in which a cubic crystal structure such as a crystal structure belonging to the space group Fm-3m is included and cations and anions are alternately arranged. Note that a cation or anion vacancy may exist.

Having features of both a layered rock-salt crystal structure and a rock-salt crystal structure can be judged by electron diffraction, a transmission electron microscope (TEM) image, a cross-sectional STEM image, and the like.

There is no distinction among cation sites in a rock-salt crystal structure. Meanwhile, a layered rock-salt crystal structure has two types of cation sites: one type is mostly occupied by lithium, and the other is occupied by the transition metal. A stacked-layer structure where two-dimensional planes of cations and two-dimensional planes of anions are alternately arranged is the same in a rock-salt crystal structure and a layered rock-salt crystal structure. Given that the center spot (transmission spot) among bright spots in an electron diffraction pattern corresponding to crystal planes that form the two-dimensional planes is at the origin point 000, the bright spot nearest to the center spot is on the (111) plane in an ideal rock-salt crystal structure, for instance, and on the (003) plane in a layered rock-salt crystal structure, for instance. For example, when electron diffraction patterns of rock-salt MgO and layered rock-salt LiMO₂ are compared to each other, the distance between the bright spots on the (003) plane of LiMO₂ is observed at a distance approximately half the distance between the bright spots on the (111) plane of MgO. Thus, when two phases of rock-salt MgO and layered rock-salt LiMO₂ are included in a region to be analyzed, a plane orientation in which bright spots with high luminance and bright spots with low luminance are alternately arranged exists in an electron diffraction pattern. A bright spot common between the rock-salt and layered rock-salt crystal structures has high luminance, whereas a bright spot caused only in the layered rock-salt crystal structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt crystal structure because there is no distinction among cation sites therein. When a crystal structure having the features of both a rock-salt crystal structure and a layered rock-salt crystal structure is observed from a given crystal orientation, layers observed with high luminance and layers observed with low luminance are alternately observed in a cross-sectional STEM image and the like, and a metal that has a lager atomic number than lithium exists in part of the layers with low luminance, i.e., the lithium layers.

Anions of a layered rock-salt crystal and anions of a rock-salt crystal form a cubic close-packed structure (face-centered cubic lattice structure). Thus, when a layered rock-salt crystal and a rock-salt crystal are in contact with each other, there is a crystal plane at which orientations of cubic close-packed structures formed of anions are aligned with each other.

The description can also be made as follows. An anion on the {111} plane of a cubic crystal structure has a triangle lattice. A layered rock-salt crystal structure, which belongs to the space group R-3m and is a rhombohedral structure, is generally represented by a composite hexagonal lattice for easy understanding of the structure, and the (0001) plane of the layered rock-salt crystal structure has a hexagonal lattice. The triangle lattice on the {111} plane of the cubic crystal has atomic arrangement similar to that of the hexagonal lattice on the (0001) plane of the layered rock-salt crystal structure. These lattices being consistent with each other can be expressed as “orientations of the cubic close-packed structures are aligned with each other”.

Note that a space group of the layered rock-salt crystal is R-3m, which is different from the space group Fm-3m of a rock-salt crystal (the space group of a general rock-salt crystal); thus, the Miller index of the crystal plane satisfying the above conditions in the layered rock-salt crystal is different from that in the rock-salt crystal. In this specification, in the layered rock-salt crystal and the rock-salt crystal, a state where the orientations of the cubic close-packed structures formed of anions are aligned with each other may be referred to as a state where crystal orientations are substantially aligned with each other. In addition, a state where three-dimensional structures have similarity, e.g., crystal orientations are substantially aligned with each other, or orientations are crystallographically the same is referred to as “topotaxy”.

The orientations of crystals in two regions being substantially aligned with each other can be judged, for example, from a TEM image, a STEM image, a high-angle annular dark field STEM (HAADF-STEM) image, an annular bright-field STEM (ABF-STEM) image, an electron diffraction pattern, and an FFT pattern of a TEM image, a STEM image, or the like. X-ray diffraction (XRD), electron diffraction, neutron diffraction, and the like can also be used for judging.

The positive electrode active material 100 of one embodiment of the present invention preferably has a layered rock-salt crystal structure belonging to the space group R-3m in a discharged state, i.e., a state where x in LiMO₂ (M is at least one of Ni, Co, and Mn) is 1. A composite oxide having a layered rock-salt crystal structure is favorably used as a positive electrode active material of a secondary battery because it has high discharge capacity and a two-dimensional diffusion path of lithium ions and is thus suitable for insertion and extraction reactions of lithium ions. For this reason, it is particularly preferable that the inner portion 100c, which accounts for the majority of the volume of the positive electrode active material 100, have a layered rock-salt crystal structure.

Meanwhile, the surface portion 100b of the positive electrode active material of one embodiment of the present invention preferably has a function of reinforcing the layered structure, which is formed of octahedrons of the transition metal M and oxygen, of the inner portion 100c so that the layered structure does not break even when a large amount of lithium is extracted from the positive electrode active material 100 by charging. Alternatively, the surface portion 100b preferably functions as a barrier layer of the positive electrode active material 100. Alternatively, the surface portion, which is the outer portion of the positive electrode active material 100, preferably reinforces the positive electrode active material 100. Here, the term “reinforce” means inhibition of a change in the structures of the surface portion 100b and the inner portion 100c of the positive electrode active material such as release of oxygen and/or inhibition of oxidative decomposition of an electrolyte on the surface 100a of the positive electrode active material. That is, “the surface portion 100b functions as a barrier layer” means that, for example, the surface portion inhibits a change in the structure of the positive electrode active material 100 and inhibits oxidative decomposition of an electrolyte.

The particle of the positive electrode active material 100 is preferably a single crystal or polycrystalline. A single crystal particle included in the positive electrode active material 100 is referred to as a single particle in some cases. The crystallite size of the positive electrode active material 100 is preferably large.

When primary particles are large, formation of secondary particles by aggregation and sintering of the primary particles is inhibited. A large primary particle leads to a large crystallite size calculated using the half width of the XRD pattern, as a foregone conclusion. Accordingly, the positive electrode active material 100 which is a single particle or which has a large crystallite size calculated using the XRD pattern has no crack or fewer cracks that might be generated between primary particles as compared to a positive electrode active material formed by sintering of a large number of primary particles. Thus, generation of cracks can be inhibited even when the volume of the positive electrode active material 100 is changed by charging and discharging.

The crystallite size calculated using the half width of the XRD pattern is preferably greater than or equal to 150 nm, further preferably greater than or equal to 180 nm, still further preferably greater than or equal to 200 nm, for example.

Note that heating for a long time, heating at high temperatures, a plurality of heating processes, or heating after addition of excess lithium is necessary to obtain a large single crystal or a large crystallite size in some cases. However, heating for a long time reduces the productivity. Heating at high temperatures might cause cation mixing between nickel ions and lithium ions. Furthermore, excess lithium might cause gelling of a binder. The single crystal size and the crystallite size are preferably set as appropriate while avoiding the above problems. For example, the crystallite size calculated from the XRD pattern is preferably less than or equal to 1000 nm, further preferably less than or equal to 800 nm.

A positive electrode active material whose crystallite size calculated from the XRD pattern is within the above range can be regarded as a positive electrode active material having a sufficiently large crystallite size and having features close to those of a single particle.

To obtain an XRD pattern for calculation of a crystallite size, a positive electrode that includes a positive electrode active material, a current collector, a binder, a conductive material, and the like may be subjected to XRD, although it is preferable that only the positive electrode active material be subjected to XRD. Note that the positive electrode active material particles present in the positive electrode might be oriented such that the crystal planes of the positive electrode active material particles are oriented in the same direction owing to, for example, pressure application in a formation process. When many of the positive electrode active material particles are oriented in the above manner, the crystallite size might fail to be calculated accurately; thus, it is preferable that to obtain an XRD pattern, a positive electrode active material layer be removed from the positive electrode, the binder and the like in the positive electrode active material layer be eliminated to some extent using a solvent or the like, and a sample holder be filled with the resultant positive electrode active material, for example. Alternatively, a powder sample of the positive electrode active material or the like may be attached onto a reflection-free silicon plate to which grease is applied, for example.

### <<XRD>>

The crystallite size can be calculated using ICSD coll. code. 172909 as literature data of lithium cobalt oxide and a diffraction pattern that is obtained with Bruker D8 ADVANCE, for example, under the following conditions: CuKα is used as an X-ray source, the 2θ range is from 15° to 90°, an increment is 0.005, and a detector is LYNXEYE XE-T. Analysis can be conducted using DIFFRAC.TOPAS ver. 6 as crystal structure analysis software, and the following settings can be used, for example.
Emission Profile: CuKa5.lam
Background: Chebychev polynomial of degree 5
Instrument
   Primary radius: 280 mm
   Secondary radius: 280 mm
   Linear PSD
      2Th angular range: 2.9
      FDS angle: 0.3
Full Axial Convolution
   Filament length: 12 mm
   Sample length: 15 mm
   Receiving Slit length: 12 mm
   Primary Sollers: 2.5
   Secondary Sollers: 2.5
Corrections
   Specimen displacement: Refine
   LP Factor: 0

A value of LVol-IB, which is a crystallite size calculated by the above method, is preferably employed as a crystallite size. Note that in a sample whose preferred orientation is calculated to be less than 0.8, too many particles are oriented in the same direction; thus, this sample is not suitable for calculation of a crystallite size in some cases.

### <<EDX>>

The concentration gradient of each of fluorine and the transition metal M contained in the positive electrode active material 100 can be evaluated by, for example, exposing a cross section of the positive electrode active material 100 using a focused ion beam (FIB) or the like and analyzing the cross section using EDX, electron probe microanalysis (EPMA), or the like.

EDX measurement for two-dimensional evaluation of an area by area scan is referred to as EDX area analysis. EDX measurement for evaluation of the atomic concentration distribution in a positive electrode active material by line scan is referred to as EDX line analysis. Furthermore, extracting data of a linear region from EDX area analysis is referred to as line analysis in some cases. The measurement of a region without scanning is referred to as point analysis.

By EDX area analysis (e.g., element mapping), the concentrations of the additive element and the transition metal M in the surface portion and the inner portion 100c of the positive electrode active material 100 can be quantitatively analyzed. By EDX line analysis, the concentration distribution and the highest concentration of the additive element can be analyzed. An analysis method in which a thinned sample is used, such as STEM-EDX, is preferred because the method makes it possible to analyze the concentration distribution in the depth direction from the surface toward the center in a specific region of the positive electrode active material regardless of the distribution in the front-back direction.

EDX area analysis or EDX point analysis of the positive electrode active material 100 of one embodiment of the present invention preferably reveals that the concentration of fluorine in the surface portion 100b is higher than that in the inner portion 100c. An increase in the concentration of fluorine on the surface of the positive electrode active material can inhibit thermal decomposition or the like of an electrolyte solution effectively.

FIG. 1A illustrates an example in which the positive electrode active material 100 with an irregular shape has the shell 100d having an island shape, and fluorine adsorbed so as to cover the surface 100a of the positive electrode active material entirely is indicated by a dotted line. However, one embodiment of the present invention is not particularly limited and fluorine does not need to cover the surface 100a entirely.

The positive electrode active material 100 does not need to have an island-shaped surface portion as long as fluorine is adsorbed on the surface 100a, and a structure illustrated in FIG. 1C may be employed, for example. FIG. 1C illustrates an example in which the surface portion 100b is provided to cover the inner portion 100c. The particle illustrated in the example in FIG. 1C has a shape close to a sphere. In the structure example illustrated in FIG. 1C, the shell 100d is provided so as to uniformly cover the surface portion 100b of a positive electrode active material entirely. The positive electrode active material illustrated in FIG. 1A and the positive electrode active material illustrated in FIG. 1C may be mixed to fabricate a positive electrode including a plurality of types of positive electrode active materials.

Although fluorine adsorbed so as to cover the surface 100a of the positive electrode active material entirely is indicated by a dotted line also in FIG. 1C, one embodiment of the present invention is not particularly limited and fluorine needs to cover at least part of the surface 100a.

This embodiment can be implemented in combination with any of the other embodiments.

### Embodiment 2

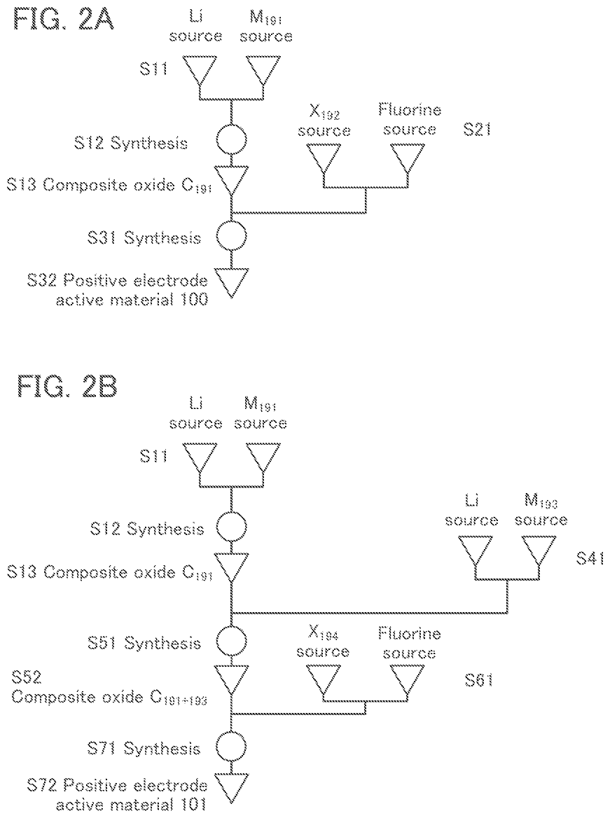

In this embodiment, an example of a formation method of the positive electrode active material 100 described in Embodiment 1 will be described with reference to FIG. 2A.

First, in Step S11, a lithium source and a transition metal M₁₉₁ source for the inner portion 100c of the positive electrode active material 100 are prepared. The transition metal M₁₉₁ source is NCM containing nickel, manganese, and cobalt.

Next, in Step S12, synthesis is performed using the lithium source and the transition metal M₁₉₁ source for the inner portion 100c of the positive electrode active material 100. The synthesis can be performed by, for example, a method in which the lithium source and the transition metal source for the inner portion 100c of the positive electrode active material 100 are mixed by a solid phase method and then heating is performed. Owing to the heating performed after the lithium source is added, secondary particles of NCM each become single particles.

In this manner, a composite oxide C₁₉₁ contained in the inner portion 100c of the positive electrode active material 100 is formed (Step S13). Although an example in which the composite oxide C₁₉₁ is synthesized is described in this embodiment, a commercially available product equivalent to the composite oxide C₁₉₁ may be used. The composite oxide C₁₉₁ is referred to as a single particle of NCM.

Next, in Step S21, an X₁₉₂ source for the surface portion 100b of the positive electrode active material 100 and a fluorine source for the surface portion 100b of the positive electrode active material 100 are prepared. As the fluorine source, a fluorine compound typified by lithium fluoride (LiF) can be used. Note that LiF is preferable because it is easily melted in an annealing process described later owing to its relatively low melting point of 848° C. As the X₁₉₂ source, magnesium fluoride (MgF₂) is used. Since magnesium fluoride is also a fluorine source, either the fluorine source or the X₁₉₂ source may be used. The use of magnesium fluoride allows magnesium to be placed in the vicinity of the surface of the positive electrode active material at high concentration, leading to formation of the surface portion 100b.

The use of lithium fluoride and magnesium fluoride is advantageous in forming the positive electrode active material 100 because the eutectic point of lithium fluoride and magnesium fluoride is around 742° C. A low eutectic point is preferable because it facilitates a later reaction in Step S31, in which case the annealing time can be shortened and the productivity can be increased.

Then, in Step S31, synthesis is performed using the composite oxide C₁₉₁ contained in the inner portion 100c of the positive electrode active material 100, the X₁₉₂ source for the surface portion 100b of the positive electrode active material 100, and a halogen source for the surface portion 100b of the positive electrode active material 100. The synthesis can be performed by a method in which the composite oxide C₁₉₁, the X₁₉₂ source, and the halogen source are mixed by a solid phase method and then heating is performed. A sol-gel method may also be used for the synthesis.

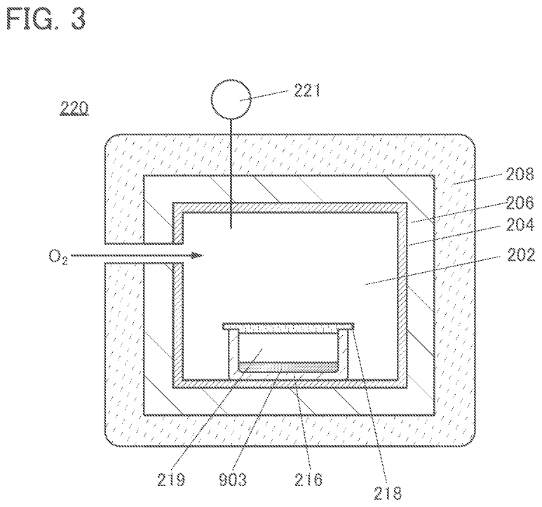

Here, an example of the annealing method in Step S31 is described with reference to FIG. 3.

A heating furnace 220 illustrated in FIG. 3 includes a space 202 in the heating furnace, a hot plate 204, a pressure gauge 221, a heater unit 206, and a heat insulator 208. It is further preferable to put a lid 218 on a container 216 in the annealing. With this structure, the atmosphere in a space 219 enclosed by the container 216 and the lid 218 can contain a fluoride. During the annealing, the state of the space 219 is maintained with the lid put on the container to make the concentration of the gasified fluoride inside the space 219 constant or not be reduced, in which case fluorine and magnesium can be contained in the vicinity of the particle surface. The atmosphere in the space 219 can contain a fluoride through volatilization of a smaller amount of fluoride because the space 219 is smaller in capacity than the space 202 in the heating furnace. This means that the atmosphere in the reaction system can contain a fluoride without a significant reduction in the amount of fluoride contained in the mixture 903. Accordingly, LiMO₂ can be produced efficiently. In addition, the use of the lid 218 allows annealing of the mixture 903 in an atmosphere containing a fluoride to be simply and inexpensively performed.

Thus, before heating in the space 202 in the heating furnace is performed, a step of providing an atmosphere containing oxygen in the space 202 in the heating furnace and a step of placing the container 216 in which the mixture 903 is placed in the space 202 in the heating furnace are performed. The steps performed in this order enable the mixture 903 to be annealed in an atmosphere containing oxygen and a fluoride. For example, flowing of a gas is performed during the annealing. During the annealing, the space 202 in the heating furnace can be sealed to prevent the gas from being discharged to the outside.

Although there is no particular limitation on a method for providing an atmosphere containing oxygen in the space 202 in the heating furnace, a method in which air is exhausted from the space 202 in the heating furnace and then an oxygen gas or a gas containing oxygen such as dry air is introduced, or a method in which an oxygen gas or a gas containing oxygen such as dry air is introduced into the space 202 in the heating furnace for a certain period of time can be used, for example. In particular, a method in which air is exhausted from the space 202 in the heating furnace and then an oxygen gas is introduced (oxygen purge) is preferably employed. Note that the air in the space 202 in the heating furnace may be regarded as an atmosphere containing oxygen.

The fluoride or the like attached to the inner walls of the container 216 and the lid 218 can be fluttered again by the heating to be attached to the mixture 903.

There is no particular limitation on the step of heating the heating furnace 220. The heating may be performed using a heating mechanism included in the heating furnace 220.

Although there is no particular limitation on the way of placing the mixture 903 in the container 216, as illustrated in FIG. 3, the mixture 903 is preferably placed such that the top surface of the mixture 903 is flat with respect to the bottom surface of the container 216, in other words, the level of the top surface of the mixture 903 becomes uniform.

The annealing in Step S31 is preferably performed while the pressure in the heating furnace is controlled using the pressure gauge 221. The atmosphere in the heating furnace is preferably in an atmospheric pressure state or a pressurized state. When heating is performed under pressure, the surface of the positive electrode active material 100 becomes smooth. Such a positive electrode active material may be less likely to be physically broken by pressure application or the like than a positive electrode active material whose surface is not smooth. For example, the positive electrode active material 100 is unlikely to be broken in a test involving pressure application such as a nail penetration test, meaning that the positive electrode active material 100 has high safety.

The annealing in Step S31 is preferably performed at an appropriate temperature for an appropriate time. The time for lowering the temperature after the annealing is preferably longer than or equal to 10 hours and shorter than or equal to 50 hours, for example. Then, the material subjected to the annealing is collected, whereby the positive electrode active material 100 is obtained.

In this manner, the positive electrode active material 100 illustrated in FIG. 1A is formed (Step S32). The surface 100a may be in contact with a solution containing fluorine after Step S31 so that fluorine is adsorbed on the surface 100a. In that case, fluorine or a fluoride can be adsorbed on the surface 100a.

In the case of adding fluorine at high concentration, the surface 100a may be in contact with a solution containing fluorine a plurality of times.

A positive electrode active material 101 illustrated in FIG. 1C can be formed through a flowchart shown in FIG. 2B, for example.

First, in Step S11, a lithium source and a transition metal M₁₉₁ source for the inner portion 100c are prepared.

Next, in Step S12, synthesis is performed using the lithium source and the transition metal M₁₉₁ source for the inner portion 100c of the positive electrode active material 101. The synthesis can be performed by, for example, a method in which the lithium source and the transition metal source for the inner portion 100c of the positive electrode active material 101 are mixed by a solid phase method and then heating is performed.

In this manner, the composite oxide C₁₉₁ contained in the inner portion 100c of the positive electrode active material 101 is formed (Step S13). Although an example in which the composite oxide C₁₉₁ is synthesized is described in this embodiment, a commercially available product equivalent to the composite oxide C₁₉₁ may be purchased and used.

Next, in Step S41, a lithium source and a transition metal M₁₉₃ source for the surface portion 100b are prepared. The transition metal M₁₉₃ source contains cobalt.

Then, in Step S51, synthesis is performed using the composite oxide C₁₉₁ contained in the inner portion 100c of the positive electrode active material 101, the lithium source, and the transition metal M₁₉₃ source. The synthesis can be performed by a method in which the composite oxide C₁₉₁, the lithium source, and the transition metal M₁₉₃ source are mixed by a solid phase method and then heating is performed.

In this manner, a composite oxide C₁₉₁₊₁₉₃ including the inner portion 100c covered with the surface portion 100b is formed (Step S52). The composite oxide C₁₉₁₊₁₉₃ has a region of LCO on an outer side than NCM.

Next, in Step S61, an X₁₉₄ source for the shell 100d and a fluorine source used for making fluorine adsorbed on a surface of the composite oxide C₁₉₁₊₁₉₃ are prepared. Lithium fluoride is used as the fluorine source and magnesium fluoride (MgF₂) is used as the X₁₉₄ source.

After that, in Step S71, synthesis is performed using the fluorine source (fluorine compound), the composite oxide C₁₉₁₊₁₉₃, and the X₁₉₄ source for the shell 100d. The synthesis can be performed by a method in which the fluorine source, the composite oxide C₁₉₁₊₁₉₃, and the X₁₉₄ source are mixed by a solid phase method and then heating is performed. A sol-gel method may also be used for the synthesis.

In this manner, the positive electrode active material 101 illustrated in FIG. 1C is formed (Step S72). The surface 100a may be in contact with a solution containing fluorine after Step S71 so that fluorine is adsorbed on the surface 100a. In that case, fluorine or a fluoride can be adsorbed on the surface 100a.

This embodiment can be implemented in combination with any of the other embodiments.

### Embodiment 3

Although an example in which the inner portion 100c and the surface portion 100b of the positive electrode active material 100 are formed using a solid phase method is described in Embodiment 2, the inner portion 100c of the positive electrode active material 100 can be formed using a coprecipitation method.

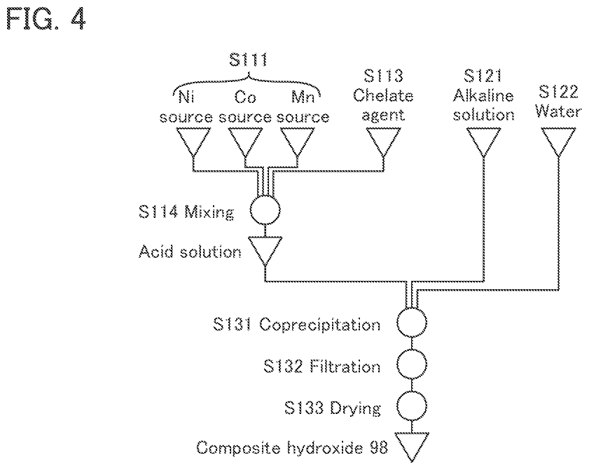

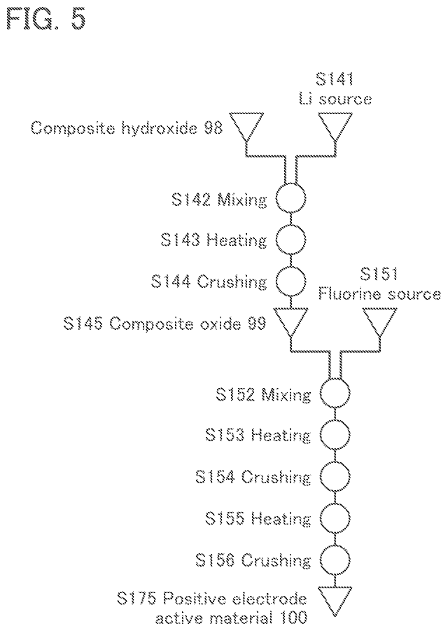

In this embodiment, an example of a formation method of the positive electrode active material 100 of one embodiment of the present invention will be described with reference to FIG. 4 and FIG. 5.

### <Step S111>

In Step S111 in FIG. 4, first, a transition metal M source including a nickel source (Ni source), a cobalt source (Co source), and a manganese source (Mn source) is prepared. In the transition metal M source, the mixed ratio of nickel, cobalt, and manganese is preferably within a range with which a layered rock-salt crystal structure can be obtained.

It is particularly preferable that the transition metal M contained in the positive electrode active material 100 contain a large amount of nickel, in which case the cost of the raw material may be lower than that in the case of containing a large amount of cobalt and charge and discharge capacity per weight may be increased. For example, the proportion of nickel in the transition metal M is preferably higher than 25 atomic %, further preferably higher than or equal to 60 atomic %, and still further preferably higher than or equal to 80 atomic % of the total of nickel, manganese, and cobalt. However, when the proportion of nickel is too high, the chemical stability and heat resistance might decrease. Thus, the proportion of nickel in the transition metal M is preferably lower than or equal to 95 atomic % of the total of nickel, manganese, and cobalt.

The transition metal M preferably contains cobalt, in which case the average discharging voltage is high and a secondary battery can be highly reliable because cobalt contributes to stabilization of the layered rock-salt crystal structure.

The transition metal M preferably contains manganese, in which case the heat resistance and chemical stability are improved. However, a too high proportion of manganese tends to decrease a discharging voltage and a discharge capacity. For this reason, the proportion of manganese in the transition metal M is preferably higher than or equal to 2.5 atomic % and lower than or equal to 34 atomic % of the total of nickel, manganese, and cobalt.

As the transition metal M source, an aqueous solution containing the transition metal M is prepared. As the nickel source, an aqueous solution of nickel salt can be used. As the nickel salt, nickel sulfate, nickel chloride, nickel nitrate, or a hydrate thereof can be used, for example. Furthermore, an organic acid salt of nickel typified by nickel acetate or a hydrate thereof can also be used. As the nickel source, an aqueous solution of nickel alkoxide or an organic nickel complex can also be used. In this specification and the like, the term “organic acid salt” denotes a compound of a metal and an organic acid such as an acetic acid, a citric acid, an oxalic acid, a formic acid, or a butyric acid.

Similarly, an aqueous solution of cobalt salt can be used as the cobalt source. As the cobalt salt, cobalt sulfate, cobalt chloride, cobalt nitrate, or a hydrate thereof can be used, for example. Furthermore, an organic acid salt of cobalt typified by cobalt acetate or a hydrate thereof can also be used. As the cobalt source, an aqueous solution of cobalt alkoxide or an organic cobalt complex can be used.

Similarly, an aqueous solution of manganese salt can be used as the manganese source. As the manganese salt, manganese sulfate, manganese chloride, manganese nitrate, or a hydrate thereof can be used. Furthermore, an organic acid salt of manganese typified by manganese acetate or a hydrate thereof can also be used as the manganese salt. As the manganese source, an aqueous solution of manganese alkoxide or an organic manganese complex can be used.

In this embodiment, an aqueous solution in which nickel sulfate, cobalt sulfate, and manganese sulfate are dissolved in pure water is prepared as the transition metal M source. In this case, the atomic ratio of nickel, cobalt, and manganese is expressed by Ni:Co:Mn=8:1:1 or in the neighborhood thereof. The aqueous solution is acidic.

### <Step S113>

As shown in Step S113 in FIG. 4, a chelate agent may be prepared. Examples of the chelate agent include glycine, oxine, 1-nitroso-2-naphthol, 2-mercaptobenzothiazole, and EDTA (ethylenediaminetetraacetic acid). Some kinds selected from glycine, oxine, 1-nitroso-2-naphthol, and 2-mercaptobenzothiazole can be used. At least one of the chelate agents is dissolved in pure water to form a chelate solution. The chelate agent serves as a complexing agent to form a chelate compound, and is preferred to a general complexing agent. Needless to say, such a complexing agent may be used instead of the chelate agent, and ammonia water can be used as the complexing agent. The chelate solution is preferably used, in which case generation of unnecessary crystal nuclei is suppressed to promote the crystal growth. Since generation of unnecessary crystal nuclei is suppressed to inhibit generation of fine particles, a composite hydroxide 98 with good particle size distribution can be obtained. Furthermore, the use of the chelate solution can slow an acid-base reaction, so that the reaction gradually progresses to form a nearly spherical secondary particle. Glycine can maintain the pH at 9.0 to 10.0, inclusive, or in the neighborhood thereof. Thus, a glycine solution is preferably used as the chelate solution, in which case the pH in the reaction vessel can be controlled in the formation of the composite hydroxide 98.

### <Step S114>

Next, in Step S114 in FIG. 4, the transition metal M source and the chelate agent are mixed, so that an acid solution is formed.

### <Step S121>

Next, in Step S121 in FIG. 4, an alkaline solution is prepared. As the alkaline solution, an aqueous solution containing sodium hydroxide, potassium hydroxide, lithium hydroxide, or ammonia can be used. An aqueous solution in which any of these substances is dissolved in pure water can be used. Alternatively, an aqueous solution in which multiple kinds selected from sodium hydroxide, potassium hydroxide, lithium hydroxide, and ammonia are dissolved in pure water may be used.

The pure water that is preferably used for the transition metal M source and the alkaline solution is water with a resistivity of 1 MΩ·cm or higher, preferably 10 MΩ·cm or higher, further preferably 15 MΩ·cm or higher. Water with the above-described resistivity has high purity and an extremely small amount of impurities.

### <Step S122>

As shown in Step S122 in FIG. 4, water is preferably prepared in a reaction vessel. The water may be an aqueous solution of a chelate agent, and pure water is preferably used. The use of pure water promotes nucleation, leading to formation of a composite hydroxide with a small particle diameter. The average particle diameter of the composite hydroxide with a small particle diameter is less than 2 μm. The water prepared in a reaction vessel can be referred to as an adjustment liquid or a filling liquid in the reaction vessel. For the case of using a chelate solution, refer to the description for Step S113.

### <Step S131>

Next, in Step S131 in FIG. 4, an acid solution and an alkaline solution are mixed to be reacted with each other. The reaction can be referred to as a coprecipitation reaction, a neutralization reaction, or an acid-base reaction.

During the coprecipitation reaction of Step S131, the pH of the reaction system is preferably higher than or equal to 9.0 and lower than or equal to 11.5.

For example, when an alkaline solution is put in a reaction vessel and an acid solution is dropped into the reaction vessel, the pH of the aqueous solution in the reaction vessel is preferably kept in the above range. Similarly, the same applies to a case where the acid solution is put in the reaction vessel and the alkaline solution is dropped thereinto. The dropping rate of the acid solution or the alkaline solution is preferably higher than or equal to 0.01 mL/min when 200 mL to 350 mL of the solution is in the reaction vessel, in which case the pH conditions can be easily controlled. The reaction vessel contains a reaction container or the like.

The aqueous solution in the reaction vessel is preferably stirred with a stirring means. The stirring means includes a stirrer, an impeller, or the like. The impeller can have two to six blades, for example, when an impeller with four blades is employed, the four blades may be arranged to make a cross shape seen from above. The rotation number of the stirring means may be from 800 rpm to 1200 rpm, inclusive. A baffle plate may be provided in the reaction vessel to change the stirring direction and the rate of flow. The use of a baffle plate improves mixing efficiency and allows synthesis of more uniform composite hydroxide particles.

The temperature of the reaction vessel is preferably controlled to be higher than or equal to 50° C. and lower than or equal to 90° C. After the temperature of the reaction vessel falls within the above temperature range, dropping of the alkaline solution or the acid solution is preferably started.

The reaction vessel preferably has an inert atmosphere. Nitrogen or argon can be used as the inert atmosphere. In the case of the nitrogen atmosphere, a nitrogen gas may be introduced at a flow rate of 0.5 L/min to 2 L/min, inclusive.

In the reaction vessel, a reflux condenser is preferably placed. The nitrogen gas can be released from the reaction vessel and water vapor can be returned to the reaction vessel with use of the reflux condenser.

Through above-described coprecipitation reaction, the composite hydroxide 98 containing the transition metal M is precipitated.

### <Step S132>

Filtration is preferably performed to collect the composite hydroxide 98 as in Step S132 in FIG. 4. Suction filtration is preferred for the filtration. The filtration may be performed using an organic solvent (e.g., acetone) after a reaction product precipitated in the reaction vessel is washed with pure water.

### <Step S133>

As shown in Step S133 in FIG. 4, the composite hydroxide 98 after the filtration is preferably dried. For example, the composite hydroxide 98 is dried in a vacuum at higher than or equal to 60° C. and lower than or equal to 200° C. for longer than or equal to 0.5 hours and shorter than or equal to 20 hours, e.g., 12 hours.

In this manner, the composite hydroxide 98 containing the transition metal M can be obtained. In this specification and the like, the composite hydroxide 98 denotes a hydroxide of a plurality of metals. The composite hydroxide 98 can be referred to as a precursor of the inner portion 100c of the positive electrode active material 100.

### <Step S141>

Next, in Step S141 in FIG. 5, a lithium source is prepared. Since a process of adding a lithium source and performing heating is performed a plurality of times at this time, the amount of lithium prepared in Step S141 is smaller than the final required amount of lithium. For example, the atomic ratio of lithium to the total of nickel, cobalt, and manganese can be, when the total is 1, greater than or equal to 0.5 and less than or equal to 0.9, and is preferably 0.7.

As the lithium source, for example, lithium hydroxide, lithium carbonate, or lithium nitrate can be used. In particular, a material having a low melting point among lithium compounds, such as lithium hydroxide with the melting point of 462° C., is preferably used. Since a positive electrode active material containing nickel at a high proportion easily causes cation mixing as compared with lithium cobalt oxide or the like, heating in Step S143 and the like needs to be performed at low temperatures. Therefore, it is preferable to use a material having a low melting point.

The particle diameter of the lithium source is preferably small because it facilitates a favorable reaction. A lithium source microparticulated by fluidized bed jet milling can be used, for example. The particle diameter here is a particle diameter at an accumulated value of 50% in particle diameter distribution obtained using a laser diffraction and scattering method (also referred to as an average particle diameter). The average particle diameter refers to D50 of the case where the particle diameter distribution is symmetrical. Note that D50 refers to a 50% cumulative particle diameter calculated using a particle size distribution analyzer (SALD-2200 manufactured by Shimadzu Corporation) using a laser diffraction and scattering method. The particle size may be measured by measuring the major diameter of the cross section of the particle obtained by analysis with a SEM, a transmission electron microscope (TEM), or the like, instead of using laser diffraction particle size distribution measurement. Note that an example of a method for measuring D50 with a SEM, TEM, or the like includes a method for measuring 20 or more particles to make a particle size distribution curve, and setting a particle diameter when the accumulation of particles accounts for 50% as D50.

<Step S142>

Next, in Step S142 in FIG. 5, the composite hydroxide and the lithium source are mixed. The mixing can be performed by a dry method or a wet method. For example, a ball mill or a bead mill can be used for the mixing. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. The lithium compound is sometimes pulverized during the mixing.

### <Step S143>

Then, heating is performed on the mixture of the composite hydroxide 98 and the lithium source (Step S143). The heating in Step S143, heating in Step S153, and heating in Step S155 in FIG. 5 may be sometimes referred to as first heating, second heating, and third heating, respectively, so as to be distinguished from one another.

An electric furnace or a rotary kiln furnace can be used as a firing device for the heating. A crucible, a sagger, a setter, or a container used in the heating is preferably made of a material that hardly releases impurities. For example, a crucible made of aluminum oxide with a purity of 99.9% can be used. In the case of mass production, a sagger made of mullite cordierite (Al₂O₃·SiO₂·MgO) can be used, for example. Such a container is preferably heated with the lid on.

The heating in Step S143 is preferably performed at a temperature higher than or equal to 400° C. and lower than or equal to 750° C., further preferably higher than or equal to 650° C. and lower than or equal to 750° C. The time for the heating in Step S143 is preferably longer than or equal to 1 hour and shorter than or equal to 30 hours, further preferably longer than or equal to 2 hours and shorter than or equal to 20 hours.

The heating atmosphere is preferably an oxygen atmosphere or an oxygen-containing atmosphere that is dry air with few moisture (e.g., with a dew point lower than or equal to −50° C., preferably lower than or equal to −80° C.).

Furthermore, crushing is preferably performed in Step S144 after the heating. The crushing can be performed in a mortar, for example. Furthermore, classification may be performed using a sieve. Through the above steps, a composite oxide 99 is obtained in Step S145. The composite oxide 99 is a material that can be called NCM.

### <Step S151>

Next, in Step S151, a fluorine source (fluorine compound) is prepared. Examples of the fluorine compound include hydrogen fluoride, halogen fluoride (e.g., ClF₃ or IF₅), a gaseous fluoride (e.g., BF₃, NF₃, PF₅, SiF₄, or SF₆), and a metal fluoride (e.g., LiF, NiF₂, AlF₃, or MgF₂). In this embodiment, magnesium fluoride or lithium fluoride is used as the fluorine source. In the case of forming the positive electrode active material 100 as a single particle, lithium fluoride is preferably used and heated so that crystal growth occurs. In the case of using lithium fluoride, the amount of lithium in Step S151 is adjusted such that the total amount of lithium prepared in Step S151 and Step S141 becomes the final required amount of lithium. The final required amount of lithium is, when the total number of atoms of nickel, cobalt, and manganese is 1, for example, preferably greater than or equal to 0.95 and less than or equal to 1.25, further preferably greater than or equal to 1.00 and less than or equal to 1.05 (atomic ratio). Although a method in which lithium is added twice in Step S141 and Step S151 and heating is performed after each of the step is described here, one embodiment of the present invention is not limited thereto. Lithium may be added three or more times and heating is performed every time after lithium is added.

### <Step S152>

Then, the composite oxide 99 obtained in Step S145 and the fluorine source (fluorine compound) are mixed.

### <Step S153>

Subsequently, heating is performed on the mixture of the composite oxide 99 and the fluorine source. The heating in Step S153 is preferably performed at sufficiently high temperatures to increase the crystallite size of the positive electrode active material 100. The temperature range may depend on the composition of the transition metal M.

In the case where the proportion of nickel in the transition metal M is high, e.g., higher than or equal to 70%, the heating temperature is preferably higher than or equal to 750° C., further preferably higher than or equal to 800° C., still further preferably higher than or equal to 850° C., for example. However, too high temperatures might cause reduction of the transition metal M including nickel to the divalent state, for example. Accordingly, the heating temperature is preferably lower than or equal to 950° C., further preferably lower than or equal to 920° C., still further preferably lower than or equal to 900° C., for example.

In the case where the proportion of nickel in the transition metal M is higher than or equal to 40% and lower than or equal to 60%, the heating temperature is preferably higher than or equal to 900° C., further preferably higher than or equal to 950° C., still further preferably around 970° C., for example. However, too high temperatures might cause the above disadvantage; accordingly, the heating temperature is preferably lower than or equal to 1020° C., further preferably lower than or equal to 990° C. For the other conditions of the heating, the description of Step S143 can be referred to.

Furthermore, crushing is preferably performed in Step S154 after the heating. The description of Step S144 can be referred to for the crushing.

### <Step S155>

In addition, the heating in Step S155 is preferably performed. The heating can reduce the residue of the lithium source or the like. The heating in Step S155 is preferably performed at a temperature higher than or equal to 400° C. and lower than or equal to 900° C., further preferably higher than or equal to 750° C. and lower than or equal to 850° C. The time for the heating in Step S155 is preferably longer than or equal to 1 hour and shorter than or equal to 30 hours, further preferably longer than or equal to 2 hours and shorter than or equal to 20 hours. Note that the heating in Step S155 is not necessarily performed.

Furthermore, crushing is preferably performed in Step S156 after the heating. The description of Step S144 can be referred to for the crushing.

Although a method in which heating is performed twice in Step S153 and Step S155 after the fluorine source is mixed in Step S152 is described with reference to FIG. 5, one embodiment of the present invention is not limited thereto. Heating may be performed three or more times.

Through the above steps, the positive electrode active material 100 can be formed (Step S175). The average particle diameter of particles of the positive electrode active material 100, which is measured using a laser diffraction and scattering method, is preferably greater than or equal to 2 μm and less than or equal to 20 μm.

This embodiment can be freely combined with any of the other embodiments.

### Embodiment 4

An example of a positive electrode formed for fabricating a secondary battery using the positive electrode active material described in any one of Embodiments 1 to 3 is described below. The secondary battery at least includes an exterior body, a current collector, an active material (a positive electrode active material or a negative electrode active material), a conductive material, and a binder. The secondary battery also includes an electrolyte solution in which a lithium salt or the like is dissolved. In the secondary battery including an electrolyte solution, a positive electrode, a negative electrode, and a separator between the positive electrode and the negative electrode are provided. The electrolyte solution preferably contains fluorine, in which case fluorine can be adsorbed on the surface of the positive electrode active material. When the electrolyte solution contains a fluoro group, fluorine adsorbed on the surface of the positive electrode active material can be stably maintained.

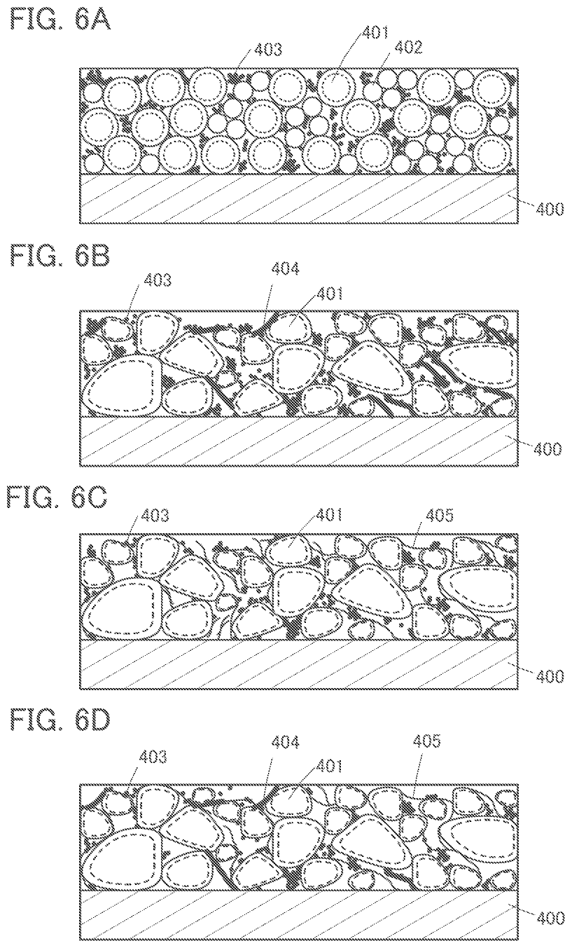

First, the positive electrode is described. FIG. 6A illustrates an example of a schematic cross-sectional view of the positive electrode.

A current collector 400 is metal foil, and the positive electrode is formed by applying slurry onto the metal foil and drying the slurry. Pressing may be performed after drying. The positive electrode is a component obtained by forming an active material layer over the current collector 400.

Slurry refers to a material solution that is used to form an active material layer over the current collector 400 and includes at least an active material, a binder, and a solvent, preferably also a conductive material mixed therewith. Slurry may also be referred to as slurry for an electrode or active material slurry; in some cases, slurry for forming a positive electrode active material layer is referred to as slurry for a positive electrode, and slurry for forming a negative electrode active material layer is referred to as slurry for a negative electrode.

A conductive material is also referred to as a conductivity-imparting agent and a conductive additive, and a carbon material is used as the conductive material. A conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other.

Typical examples of the carbon material used as the conductive material include carbon black (e.g., furnace black, particulate carbon such as acetylene black, and graphite).

In FIG. 6A, acetylene black 403 is illustrated as a conductive material. FIG. 6A illustrates an example in which a second active material 402 with a smaller particle diameter than the positive electrode active material 100 described in Embodiments 1 to 3 is mixed. The positive electrode including particles with different particle sizes can have high density.

In the positive electrode of the secondary battery, a binder (a resin) is mixed in order to fix the current collector 400 such as metal foil and the active material. The binder is also referred to as a binding agent. Since the binder is a high molecular material, a large amount of binder lowers the proportion of the active material in the positive electrode, thereby reducing the discharge capacity of the secondary battery. Therefore, the amount of binder mixed is reduced to a minimum. In FIG. 6A, a region not filled with any of an active material 401, the second active material 402, and the acetylene black 403 indicates a space or a binder.

In FIG. 6A, a boundary between an inner portion and a shell of the active material 401 is indicated by a dotted line. The active material 401 in FIG. 6A has a spherical shape, for example, which corresponds to the positive electrode active material 101 in FIG. 1C. The shell contains magnesium at a higher concentration than the inner portion; thus, overheating or ignition of a lithium-ion secondary battery can be inhibited and thermal safety can be improved.

Although FIG. 6A illustrates an example in which the active material 401 has a spherical shape, there is no particular limitation and other various shapes can be employed. The cross-sectional shape of the active material 401 may be an ellipse, a rectangle, a trapezoid, a pyramid, a quadrilateral with rounded corners, or an asymmetrical shape.

FIG. 6B illustrates an example different from that in FIG. 6A. The active material 401 in FIG. 6B has an irregular shape, for example, which corresponds to the positive electrode active material 100 in FIG. 1A. In FIG. 6B, a boundary between the inner portion and the shell of the active material 401 is indicated by a dotted line. The shell contains magnesium at a higher concentration than the inner portion; thus, overheating or ignition of a lithium-ion secondary battery can be inhibited and thermal safety can be improved.

In the positive electrode in FIG. 6B, graphene 404 is used as a carbon material used as the conductive material.

Graphene, which has electrically, mechanically, or chemically remarkable characteristics, is a carbon material that is expected to be applied to a variety of fields, such as field-effect transistors and solar batteries.

Graphene in this specification and the like includes multilayer graphene and multi graphene. In other words, graphene contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. The carbon material used as the conductive material in the positive electrode is not limited to graphene, and can be a graphene compound. A graphene compound includes graphene oxide, multilayer graphene oxide, multi graphene oxide, reduced graphene oxide, reduced multilayer graphene oxide, reduced multi graphene oxide, graphene quantum dots, and the like. In other words, a graphene compound may include a functional group. Graphene or a graphene compound is preferably bent. Graphene or a graphene compound may be rolled, and rolled graphene is referred to as a carbon nanofiber in some cases.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms. The reduced graphene oxide functions by itself and may have a stacked-layer structure. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

As a graphene compound, fluorine-containing graphene may be used. Fluorine-containing graphene can be formed by making graphene and a fluorine compound contact each other (which is called fluorination treatment). The fluorination treatment is preferably performed using fluorine (F₂) or a fluorine compound. The fluorine compound is preferably hydrogen fluoride, halogen fluoride (e.g., ClF₃ or IF₅), a gaseous fluoride (e.g., BF₃, NF₃, PF₅, SiF₄, or SF₆), a metal fluoride (e.g., LiF, NiF₂, AlF₃, or MgF₂), or the like. The fluorination treatment is preferably performed using a gaseous fluoride, which may be diluted with an inert gas. The fluorination treatment is preferably performed at room temperature or in a temperature range higher than or equal to 0° C. and lower than or equal to 250° C., which includes room temperature. Performing the fluorination treatment at higher than or equal to 0° C. enables adsorption of fluorine onto a surface of graphene.

A graphene compound sometimes has excellent electrical characteristics of high conductivity and excellent physical properties of high flexibility and high mechanical strength. A graphene compound has a sheet-like shape. A graphene compound has a curved surface in some cases, thereby enabling low-resistance surface contact. Furthermore, a graphene compound sometimes has extremely high conductivity even with a small thickness, and thus a small amount of a graphene compound allows a conductive path to be efficiently formed in an active material layer. Hence, the use of the graphene compound as a conductive material can increase the area where the active material and the conductive material are in contact with each other. The graphene compound preferably covers 80% or more of the area of the active material. Note that a graphene compound preferably clings to at least part of an active material particle. A graphene compound preferably overlays at least part of an active material particle. The shape of a graphene compound preferably conforms to at least part of the shape of an active material particle. The shape of an active material particle means, for example, an uneven surface of a single active material particle or an uneven surface formed by a plurality of active material particles. A graphene compound preferably surrounds at least part of an active material particle. A graphene compound may have a hole.

In FIG. 6B, a positive electrode active material layer containing the active material 401, the graphene 404, and the acetylene black 403 is formed over the current collector 400. The graphene 404 is formed to partly coat or adhere to the surfaces of the plurality of particles of the active material 401, so that the graphene 404 makes surface contact with the particles of the active material 401. Note that the graphene 404 preferably clings to at least part of the active material 401. The graphene 404 preferably overlays at least part of the active material 401. The shape of the graphene 404 preferably conforms to at least part of the shape of the active material 401. The shape of the active material means, for example, an uneven surface of a single active material particle or an uneven surface formed by a plurality of active material particles. The graphene 404 preferably surrounds at least part of the active material 401. The graphene 404 may have a hole.

In the step of mixing the graphene 404 and the acetylene black 403 to obtain an electrode slurry, the weight of mixed acetylene black is preferably 1.5 to 20 times, further preferably 2 to 9.5 times the weight of graphene.

When the graphene 404 and the acetylene black 403 are mixed in the above ratio range, the acetylene black 403 can be dispersed uniformly and less likely to be aggregated at the time of preparing the slurry. Furthermore, when the graphene 404 and the acetylene black 403 are mixed in the above ratio range, the positive electrode can have a higher density than that using only the acetylene black 403 as the conductive material. As the electrode density is higher, the capacity per unit volume can be higher. Specifically, the density of the positive electrode active material layer measured by gravimetry can be higher than 3.5 g/cc. In addition, it is preferable that the positive electrode active material described in Embodiments 1 to 3 be used for the positive electrode and the graphene 404 and the acetylene black 403 be mixed in the above ratio range, in which case synergy for higher capacity of the secondary battery can be expected.

A positive electrode containing a first carbon material (graphene) and a second carbon material (acetylene black) which are mixed in the above range enables fast charging, although having lower electrode density than a positive electrode containing only graphene as a conductive material. In addition, it is preferable that the positive electrode active material described in Embodiments 1 to 3 be used for the positive electrode and the graphene 404 and the acetylene black 403 be mixed in the above ratio range, in which case synergy for higher stability and compatibility with faster charging of the secondary battery can be expected.

The above features are advantageous for secondary batteries for vehicles.

When a vehicle becomes heavier with increasing number of secondary batteries, more energy is consumed to move the vehicle, which decreases the mileage. With the use of high-density secondary batteries, the mileage of the vehicle can be maintained with almost no increase in the total weight of a vehicle including a secondary battery having the same weight.

Since power is needed to charge the secondary battery with higher capacity in the vehicle, the charging is desirably finished in a short time. What is called a regenerative charging, in which electric power temporarily generated when the vehicle is braked is used for charging, is performed under high rate charging conditions; thus, a secondary battery for a vehicle is desired to have favorable rate characteristics.

Using the positive electrode active material described in Embodiments 1 to 3 for the positive electrode and mixing acetylene black and graphene within an optimal range enable both higher electrode density and formation of an appropriate space needed for ion conduction, whereby a secondary battery for a vehicle which has high energy density and favorable output characteristics can be obtained.

This structure is also effective in a portable information terminal, and using the positive electrode active material described in Embodiments 1 to 3 for the positive electrode and setting the mixing ratio of acetylene black to graphene in the optimal range enable a small secondary battery with high capacity. Setting the mixing ratio of acetylene black to graphene in the optimal range also enables fast charging of a portable information terminal.

In FIG. 6B, the boundary between the inner portion and the surface portion of the active material 401 is indicated by a dotted line in the active material 401. In FIG. 6B, a region not filled with any of the active material 401, the graphene 404, and the acetylene black 403 indicates a space or a binder. A space is required for the electrolyte solution to penetrate the positive electrode; too many spaces lower the electrode density, too few spaces do not allow the electrolyte solution to penetrate the positive electrode, and a space that remains after the secondary battery is completed lowers the efficiency.

Using the positive electrode active material described in Embodiments 1 to 3 for the positive electrode and mixing acetylene black and graphene within an optimal range enable both higher electrode density and formation of an appropriate space needed for ion conduction, whereby a secondary battery which has high energy density and favorable output characteristics can be obtained.

FIG. 6C illustrates an example of a positive electrode in which a carbon nanotube 405, which is an example of fiber shaped carbon, is used instead of graphene. FIG. 6C illustrates an example different from that in FIG. 6B. The use of the carbon nanotube 405 can prevent aggregation of carbon black such as the acetylene black 403 and can increase the dispersibility. The fiber length of the carbon nanotube 405 is longer than or equal to 1 μm and shorter than or equal to 20 μm, and the fiber diameter is greater than or equal to 10 nm and less than or equal to 100 nm.

A fluorine-containing carbon nanotube may be used. A fluorine-containing carbon nanotube can be formed by making a carbon nanotube and a fluorine compound contact each other (which is called fluorination treatment). The description of the fluorination treatment using graphene can be referred to for the fluorination treatment using carbon nanotube.

In FIG. 6C, a region not filled with any of the active material 401, the carbon nanotube 405, and the acetylene black 403 indicates a space or a binder.

FIG. 6D illustrates another example of a positive electrode. FIG. 6C illustrates an example in which the carbon nanotube 405 is used in addition to the graphene 404. The use of both the graphene 404 and the carbon nanotube 405 can prevent aggregation of carbon black such as the acetylene black 403 and can further increase the dispersibility.

Fluorine-containing acetylene black may be used. Fluorine-containing acetylene black can be formed by making acetylene black and a fluorine compound contact each other (which is called fluorination treatment). The description of the fluorination treatment using graphene can be referred to for the fluorination treatment using acetylene black.

In FIG. 6D, regions not filled with any of the active material 401, the carbon nanotube 405, the graphene 404, and the acetylene black 403 indicate spaces or binders.

A secondary battery can be fabricated by using any one of the positive electrodes in FIGS. 6A to 6D; setting, in a container (e.g., an exterior body or a metal can), a stack in which a separator is provided over the positive electrode and a negative electrode is provided over the separator; and filling the container with an electrolyte solution.

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

As the binder, for example, a water-soluble polymer is preferably used. As the water-soluble polymer, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such a water-soluble polymer be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, poly(vinylidene fluoride) (PVDF), polyacrylonitrile (PAN), ethylene-propylene-diene polymer, polyvinyl acetate, or nitrocellulose is preferably used.

At least two of the above materials may be used in combination for the binder.

For example, a material having a significant viscosity modifying effect and another material may be used in combination. For example, a rubber material or the like has high adhesion or high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. An example of a water-soluble polymer having a significant viscosity modifying effect is the above-mentioned polysaccharide; for instance, a cellulose derivative such as carboxymethyl cellulose (CMC), methyl cellulose, ethyl cellulose, hydroxypropyl cellulose, diacetyl cellulose, or regenerated cellulose, or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material or other components in the formation of a slurry for an electrode. In this specification, cellulose and a cellulose derivative used as a binder of an electrode include salts thereof.

A water-soluble polymer stabilizes the viscosity by being dissolved in water and allows stable dispersion of the active material or another material combined as the binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of an electrolyte. Here, a passivation film refers to a film without electric conductivity or a film with extremely low electric conductivity, and can inhibit the decomposition of the electrolyte at a potential at which a battery reaction occurs when the passivation film is formed on the active material surface, for example. It is preferable that the passivation film can conduct lithium ions while suppressing electrical conduction.

Although the above structure is an example of a secondary battery using an electrolyte solution, one embodiment of the present invention is not limited thereto. For example, a semi-solid-state battery can be fabricated using the positive electrode active material 100 described in Embodiments 1 to 3.

In this specification and the like, a semi-solid-state battery refers to a battery in which at least one of an electrolyte layer, a positive electrode, and a negative electrode includes a semi-solid-state material. The term “semi-solid-state” here does not mean that the proportion of a solid-state material is 50%. The term “semi-solid-state” means having properties of a solid, such as a small volume change, and also having some of properties close to those of a liquid, such as flexibility. A single material or a plurality of materials can be used to satisfy the above properties. For example, a porous solid-state material infiltrated with a liquid material may be used.

In this specification and the like, a polymer electrolyte secondary battery refers to a secondary battery in which an electrolyte layer between a positive electrode and a negative electrode includes a polymer. Polymer electrolyte secondary batteries include a dry (or true) polymer electrolyte battery and a polymer gel electrolyte battery. A polymer electrolyte secondary battery may be referred to as a semi-solid-state battery.

A semi-solid-state battery fabricated using the positive electrode active material 100 described in Embodiments 1 to 3 is a secondary battery having high charge and discharge capacity. The semi-solid-state battery can have high charging and discharging voltages. Alternatively, a highly safe or highly reliable semi-solid-state battery can be achieved.

This embodiment can be freely combined with any of the other embodiments.

### Embodiment 5

This embodiment describes examples of shapes of a secondary battery including a positive electrode formed by the formation method described in the foregoing embodiments.

### [Coin-Type Secondary Battery]

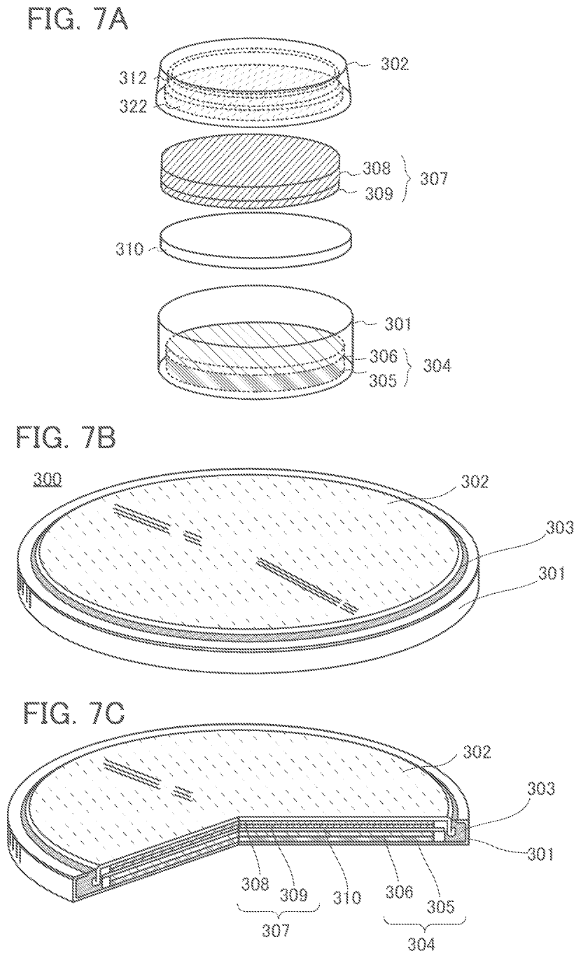

An example of a coin-type secondary battery is described. FIG. 7A, FIG. 7B, and FIG. 7C are an exploded perspective view, an external view, and a cross-sectional view of a coin-type (single-layer flat) secondary battery. Coin-type secondary batteries are mainly used in small electronic devices.

For easy understanding, FIG. 7A is a schematic view illustrating overlap (a vertical relation and a positional relation) between components. Thus, FIG. 7A and FIG. 7B do not completely correspond with each other.

In FIG. 7A, a positive electrode 304, a separator 310, a negative electrode 307, a spacer 322, and a washer 312 are overlaid. They are sealed with a negative electrode can 302, a positive electrode can 301, and a gasket. Note that the gasket for sealing is not illustrated in FIG. 7A. The spacer 322 and the washer 312 are used to protect the inside or fix the position of the components inside the cans at the time when the positive electrode can 301 and the negative electrode can 302 are bonded with pressure. For the spacer 322 and the washer 312, stainless steel or an insulating material is used.

The positive electrode 304 is a stack in which a positive electrode active material layer 306 is formed over a positive electrode current collector 305.

FIG. 7B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution, for example. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 7C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is fabricated.

With the above structure, the coin-type secondary battery 300 can have a high level of safety.

### [Cylindrical Secondary Battery]

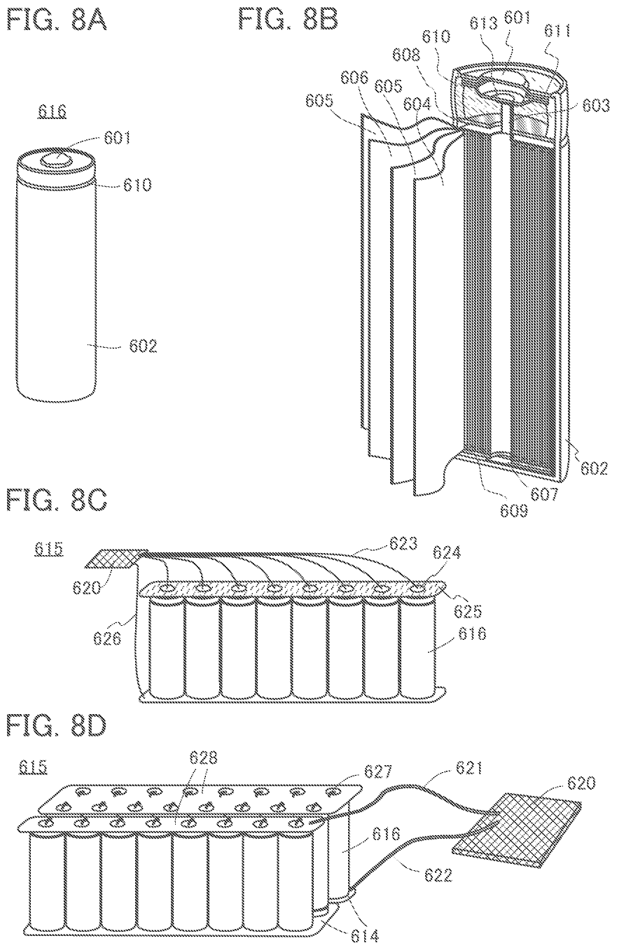

An example of a cylindrical secondary battery is described with reference to FIG. 8A. As illustrated in FIG. 8A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 8B schematically illustrates a cross section of a cylindrical secondary battery. The cylindrical secondary battery illustrated in FIG. 8B includes the positive electrode cap (battery cap) 601 on the top surface and the battery can (outer can) 602 on the side and bottom surfaces. The positive electrode cap 601 and the battery can (outer can) 602 are insulated from each other by the gasket (insulating gasket) 610.

Inside the battery can 602 having a hollow cylindrical shape, a wound body in which a strip-like positive electrode 604 and a strip-like negative electrode 606 are wound with a strip-like separator 605 located therebetween is provided. Although not illustrated, the wound body is wound around the central axis. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel, aluminum, and the like in order to prevent corrosion due to the electrolyte solution. Inside the battery can 602, the wound body in which the positive electrode, the negative electrode, and the separator are wound is provided between a pair of insulating plates 608 and 609 that face each other. The inside of the battery can 602 provided with the wound body is filled with a nonaqueous electrolyte solution (not illustrated). As the nonaqueous electrolyte solution, an electrolyte solution similar to that for the coin-type secondary battery can be used.

Since the positive electrode and the negative electrode of the cylindrical storage battery are wound, active materials are preferably formed on both sides of the current collectors.

The positive electrode active material 100 obtained in Embodiments 1 to 3 is used in the positive electrode 604, whereby the cylindrical secondary battery 616 can have a high level of safety.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a positive temperature coefficient (PTC) element 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 8C illustrates an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a charge and discharge control circuit for performing charging, discharging, and the like or a protection circuit for preventing overcharging and/or overdischarging can be used.

FIG. 8D illustrates an example of the power storage system 615. The power storage system 615 includes a plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel or connected in series. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 8D, the power storage system 615 is electrically connected to the control circuit 620 through a wiring 621 and a wiring 622. The wiring 621 is electrically connected to the positive electrodes of the plurality of secondary batteries 616 through the conductive plate 628. The wiring 622 is electrically connected to the negative electrodes of the plurality of secondary batteries 616 through the conductive plate 614.

### [Other Structure Examples of Secondary Battery]

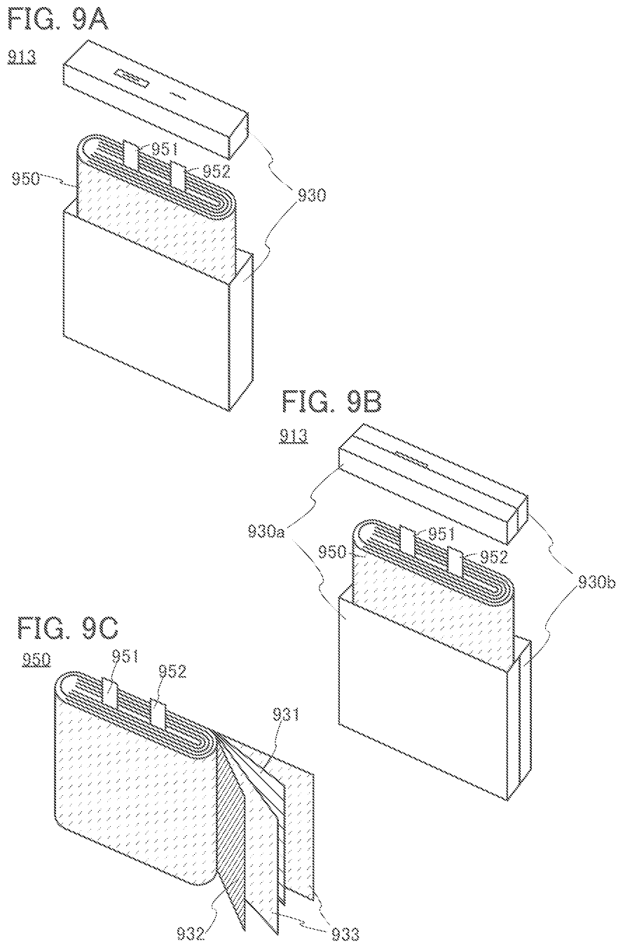

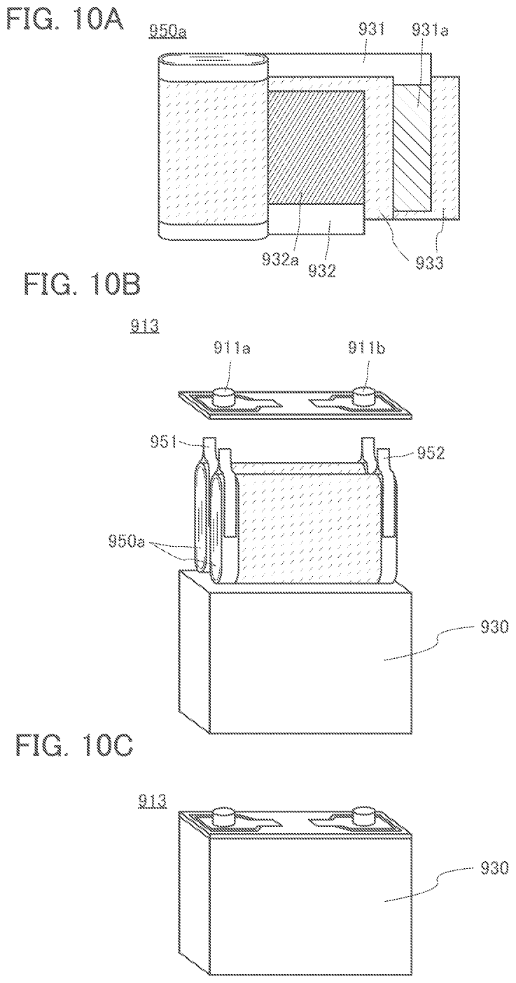

Structure examples of secondary batteries are described with reference to FIGS. 9A to 9C and FIGS. 10A to 10C.

A secondary battery 913 illustrated in FIG. 9A includes a wound body 950 provided with a terminal 951 and a terminal 952 inside a housing 930. The wound body 950 is immersed in an electrolyte solution inside the housing 930. The terminal 952 is in contact with the housing 930. The use of an insulator or the like inhibits contact between the terminal 951 and the housing 930. Note that in FIG. 9A, the housing 930 divided into two pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 9B, the housing 930 in FIG. 9A may be formed using a plurality of materials. For example, in the secondary battery 913 in FIG. 9B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 9C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be overlaid.

As illustrated in FIGS. 10A to 10C, the secondary battery 913 may include a wound body 950a. The wound body 950a illustrated in FIG. 10A includes the negative electrode 931, the positive electrode 932, and the separators 933. The negative electrode 931 includes a negative electrode active material layer 931a. The positive electrode 932 includes a positive electrode active material layer 932a.

The positive electrode active material 100 obtained in Embodiments 1 to 3 is used in the positive electrode 932, whereby the secondary battery 913 can have a high level of safety.

The separator 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 10B, the negative electrode 931 is electrically connected to the terminal 951 by ultrasonic bonding, welding, or pressure bonding. The terminal 951 is electrically connected to a terminal 911a. The positive electrode 932 is electrically connected to the terminal 952 by ultrasonic bonding, welding, or pressure bonding. The terminal 952 is electrically connected to a terminal 911b.

As illustrated in FIG. 10C, the wound body 950a and an electrolyte solution are covered with the housing 930, whereby the secondary battery 913 is completed. The housing 930 is preferably provided with a safety valve, an overcurrent protection element, and the like. A safety valve is a valve to be released by a predetermined internal pressure of the housing 930 in order to prevent the battery from exploding.

As illustrated in FIG. 10B, the secondary battery 913 may include a plurality of wound bodies 950a. The use of the plurality of wound bodies 950a enables the secondary battery 913 to have higher discharge capacity. The description of the secondary battery 913 in FIGS. 9A to 9C can be referred to for the other components of the secondary battery 913 in FIGS. 10A and 10B.

### <Laminated Secondary Battery>

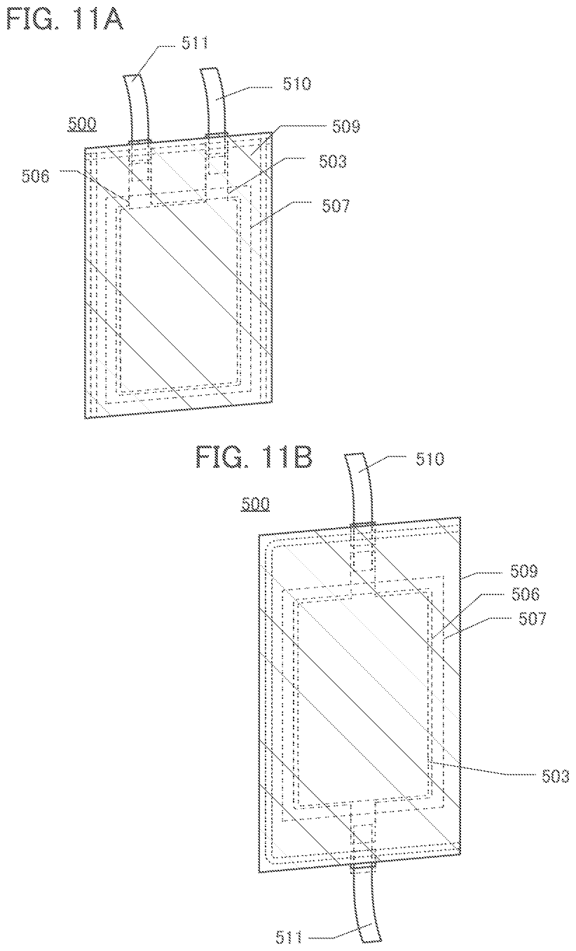

Next, examples of the appearance of a laminated secondary battery are illustrated in FIGS. 11A and 11B. FIGS. 11A and 11B each illustrate a positive electrode 503, a negative electrode 506, a separator 507, an exterior body 509, a positive electrode lead electrode 510, and a negative electrode lead electrode 511.

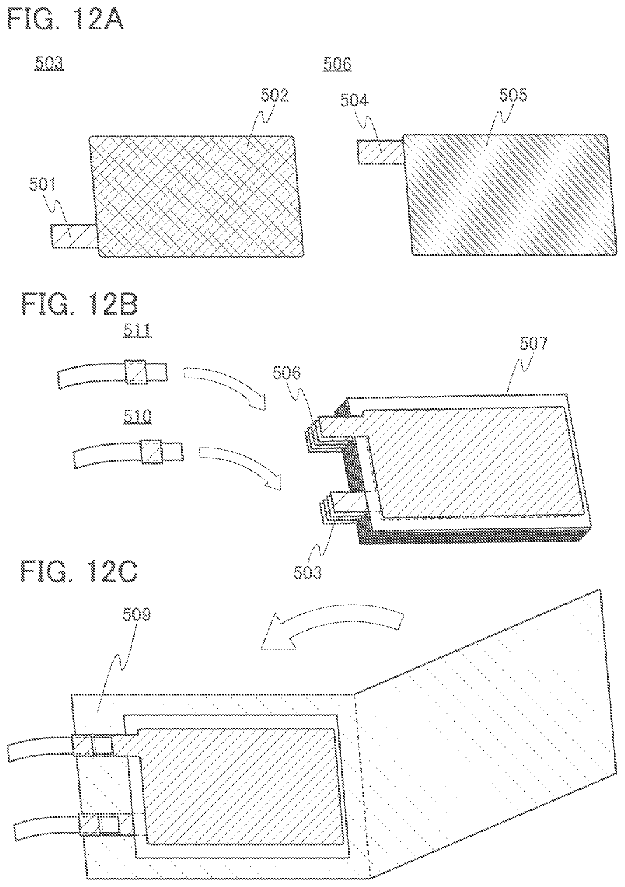

FIG. 12A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas or the shapes of the tab regions included in the positive electrode and the negative electrode are not limited to those illustrated in FIG. 12A.

### <Method for Fabricating Laminated Secondary Battery>

An example of a method for fabricating the laminated secondary battery having the appearance illustrated in FIG. 11A will be described with reference to FIGS. 12B and 12C.

First, the negative electrode 506, the separator 507, and the positive electrode 503 are stacked. FIG. 12B illustrates the negative electrodes 506, the separators 507, and the positive electrodes 503 that are stacked. The secondary battery described here as an example includes five negative electrodes and four positive electrodes. The component at this stage can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a dashed line as illustrated in FIG. 12C. Then, the outer edges of the exterior body 509 are bonded to each other. The bonding can be performed by thermocompression, for example. At this time, a part (or one side) of the exterior body 509 is left unbonded (to provide an inlet) so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be fabricated.

The positive electrode active material 100 obtained in Embodiments 1 to 3 is used in the positive electrodes 503, whereby the secondary battery 500 can have a high level of safety.

### Embodiment 6

In this embodiment, examples of vehicles each including the secondary battery of one embodiment of the present invention are described.

The secondary battery can be used in vehicles, typically automobiles. Examples of the automobiles include next-generation clean energy vehicles such as hybrid vehicles (HVs), electric vehicles (EVs), and plug-in hybrid vehicles (also referred to as PHEVs or PHVs). The secondary battery can be used as one of the power sources provided in the automobiles. The vehicle is not limited to an automobile. Examples of the vehicles include a train, a monorail train, a ship, a submarine (a deep-submergence vehicle and an unmanned submarine), a flying object (a helicopter, an unmanned aircraft (a drone), an airplane, a rocket, and artificial satellite), an electric bicycle, and an electric motorcycle. The secondary battery of one embodiment of the present invention can be used in these vehicles.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery and a starter battery. The second battery 1311 specifically needs high output and does not necessarily have high capacity, and the capacity of the second battery 1311 is lower than that of the first batteries 1301a and 1301b.

The internal structure of the first battery 1301a may be the wound structure illustrated in FIG. 9C or FIG. 10A or the stacked structure illustrated in FIG. 11A or FIG. 11B.

Although this embodiment shows an example where the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. A plurality of secondary batteries can be collectively referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DC-DC circuit 1306. In the case where there is a rear motor 1317 for the rear wheels, the first battery 1301a is used to rotate the rear motor 1317.

The second battery 1311 supplies electric power to in-vehicle parts for 14 V (such as an audio 1313, power windows 1314, and lamps 1315) through a DC-DC circuit 1310.

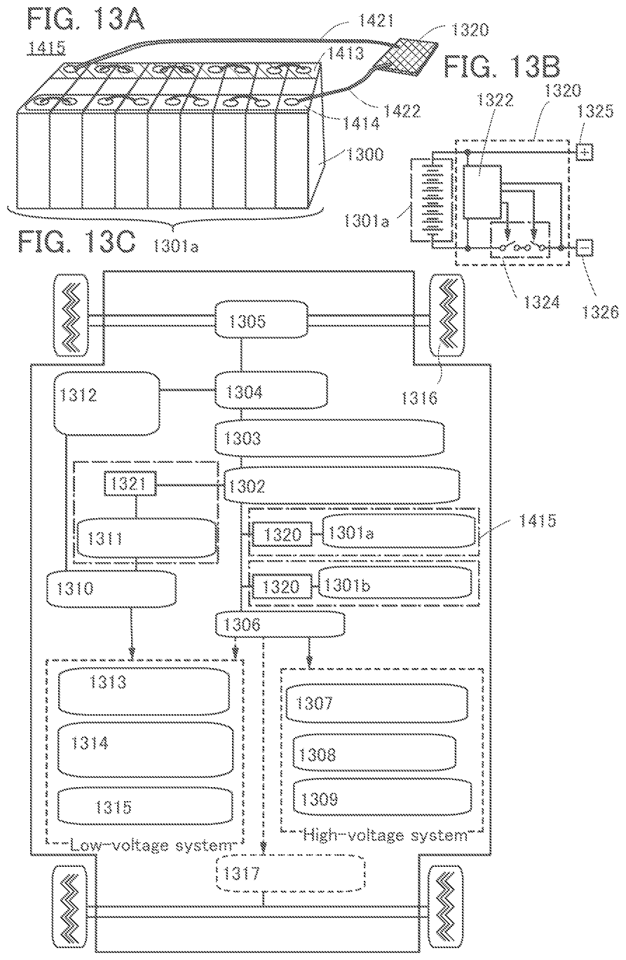

Next, the first battery 1301a is described with reference to FIG. 13A.

FIG. 13A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode of each battery is fixed by a fixing portion 1414 made of an insulator. Although this embodiment shows an example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414, a battery container box, or the like. Furthermore, the one electrode of each battery is electrically connected to a control circuit portion 1320 through a wiring 1421. The other electrode of each battery is electrically connected to the control circuit portion 1320 through a wiring 1422.

Next, FIG. 13B illustrates an example of a block diagram of the battery pack 1415 illustrated in FIG. 13A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery used, and imposes the upper limit of current from the outside, the upper limit of output current to the outside, or the like. The range from the lower limit voltage to the upper limit voltage of the secondary battery falls within the recommended voltage range. When a voltage falls outside the range, the switch portion 1324 operates and functions as a protection circuit. The control circuit portion 1320 can also be referred to as a protection circuit because it controls the switch portion 1324 to prevent overdischarging and/or overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to including a switch having a Si transistor using single crystal silicon; the switch portion 1324 may be formed using a power transistor containing germanium (Ge), silicon germanium (SiGe), gallium arsenide (GaAs), gallium aluminum arsenide (GaAlAs), indium phosphide (InP), silicon carbide (SiC), zinc selenide (ZnSe), gallium nitride (GaN), gallium oxide (GaOₓ, where x is a real number greater than 0), or the like.

The first batteries 1301a and 1301b mainly supply electric power to in-vehicle parts for 42 V (for a high-voltage system), and the second battery 1311 supplies electric power to in-vehicle parts for 14 V (for a low-voltage system). A lead battery is usually used for the second battery 1311 due to cost advantage.

In this embodiment, an example in which a lithium-ion battery is used as both the first battery 1301a and the second battery 1311 is described. As the second battery 1311, a lead storage battery, an all-solid-state battery, or an electric double layer capacitor may alternatively be used.

Regenerative energy generated by rolling of tires 1316 is transmitted to the motor 1304 through a gear 1305, and is stored in the second battery 1311 through a motor controller 1303, a battery controller 1302, or the control circuit portion 1321. Alternatively, the regenerative energy is stored in the first battery 1301a through the battery controller 1302 and the control circuit portion 1320. Alternatively, the regenerative energy is stored in the first battery 1301b through the battery controller 1302 and the control circuit portion 1320. For efficient charging with regenerative energy, the first batteries 1301a and 1301b are preferably capable of fast charging.

The battery controller 1302 can set the charge voltage, charge current, and the like of the first batteries 1301a and 1301b. The battery controller 1302 can set charge conditions in accordance with charge characteristics of a secondary battery used, so that fast charging can be performed.

Although not illustrated, when the electric vehicle is connected to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a plug of the charger or a connection cable of the charger is sometimes provided with a control circuit. The control circuit portion 1320 is also referred to as an electronic control unit (ECU). The ECU is connected to a controller area network (CAN) provided in the electric motor vehicle. The CAN is a type of a serial communication standard used as an in-vehicle LAN. The ECU includes a microcomputer. Moreover, the ECU uses a CPU or a GPU.

External chargers installed at charge stations and the like have a 100 V outlet, a 200 V outlet, or a three-phase 200V outlet with 50 kW, for example. Furthermore, charging can be performed by electric power supplied from external charge equipment with a contactless power feeding method or the like.

For fast charging, secondary batteries that can withstand charging at high voltage have been desired to perform charging in a short time.

It is possible to achieve a secondary battery in which graphene is used as a conductive material, the electrode layer is formed thick to suppress a reduction in capacity while increasing the loading amount, and the electrical characteristics are significantly improved in synergy with maintenance of high capacity. This secondary battery is particularly effectively used in a vehicle and can achieve a vehicle that has a long range, specifically a driving range per charge of 500 km or greater, without increasing the proportion of the weight of the secondary battery to the weight of the entire vehicle.

Specifically, in the secondary battery in this embodiment, the use of the positive electrode active material 100 described in Embodiments 1 to 3 can increase the operating voltage, and the increase in charge voltage can increase the available capacity. Moreover, using the positive electrode active material 100 described in Embodiments 1 to 3 in the positive electrode can provide an automotive secondary battery having a high level of safety.

Next, examples in which the secondary battery of one embodiment of the present invention is mounted on a vehicle, typically a transport vehicle, will be described.

Mounting the secondary battery illustrated in any one of FIG. 8D, FIG. 10C, and FIG. 13A on vehicles can achieve next-generation clean energy vehicles such as hybrid vehicles (HVs), electric vehicles (EVs), and plug-in hybrid vehicles (PHVs). The secondary battery can also be mounted on agricultural machines, motorized bicycles including motor-assisted bicycles, motorcycles, electric wheelchairs, electric carts, vessels, submarines, aircraft, rockets, artificial satellites, space probes, planetary probes, or spacecraft. The secondary battery of one embodiment of the present invention can have high capacity. Thus, the secondary battery of one embodiment of the present invention is suitable for reduction in size and weight and is preferably used in transport vehicles.

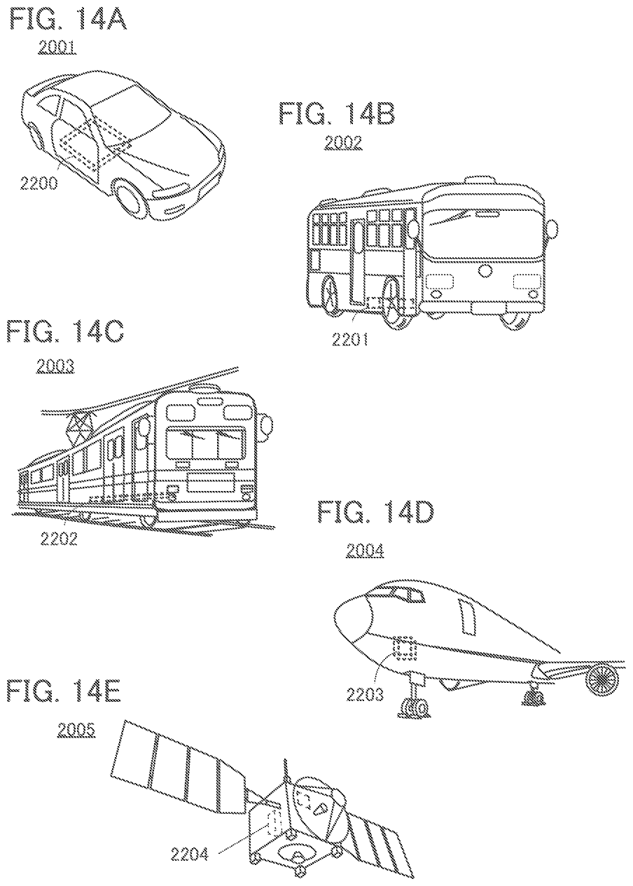

FIGS. 14A to 14D illustrate examples of transport vehicles using one embodiment of the present invention. An automobile 2001 illustrated in FIG. 14A is an electric vehicle that runs on the power of an electric motor. Alternatively, the automobile 2001 is a hybrid electric vehicle capable of driving using either an electric motor or an engine as appropriate. In the case where the secondary battery is mounted on the vehicle, the secondary battery exemplified in Embodiment 5 is provided at one position or several positions. The automobile 2001 illustrated in FIG. 14A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery included in the automobile 2001 is supplied with electric power through external charge equipment by a plug-in system, a contactless power feeding system, or the like. In charging, a given method such as CHAdeMO (registered trademark) or Combined Charging System can be employed as a charge method, the standard of a connector, and the like as appropriate. Charge equipment may be a charge station provided in a commerce facility or a power source in a house. For example, with the use of the plug-in technique, the power storage device mounted on the automobile 2001 can be charged by being supplied with electric power from outside. The charging can be performed by converting AC electric power into DC electric power through a converter such as an AC-DC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 14B illustrates a large transporter 2002 having a motor controlled by electricity as an example of a transport vehicle. A secondary battery module of the transporter 2002 includes a cell unit of four secondary batteries with a nominal voltage of 3.0 V or higher and 5.0 V or lower, for example, and 48 cells are connected in series to have a maximum voltage of 170 V. A battery pack 2201 has the same function as that in FIG. 14A except, for example, the number of secondary batteries configuring the secondary battery module; thus, the description is omitted.

FIG. 14C illustrates a large transportation vehicle 2003 having a motor controlled by electricity as an example. A secondary battery module of the transportation vehicle 2003 has 100 or more secondary batteries with a nominal voltage of 3.0 V or higher and 5.0 V or lower connected in series, and the maximum voltage is 600 V. Thus, the secondary batteries are required to have few variations in the characteristics. With the use of a secondary battery with the positive electrode active material 100 described in Embodiments 1 to 3, a secondary battery with stable battery characteristics can be fabricated, which enables the volume production at low costs in terms of the yield. A battery pack 2202 has the same function as that in FIG. 14A except, for example, the number of secondary batteries configuring the secondary battery module; thus, the description is omitted.

FIG. 14D illustrates an aircraft 2004 having a combustion engine as an example. The aircraft 2004 illustrated in FIG. 14D is regarded as a kind of transportation vehicles because it has wheels for takeoff and landing, and includes a battery pack 2203 that includes a charge control device and a secondary battery module configured by connecting a plurality of secondary batteries.

The secondary battery module of the aircraft 2004 has eight 4 V secondary batteries connected in series and has a maximum voltage of 32 V, for example. The battery pack 2203 has the same function as that in FIG. 14A except, for example, the number of secondary batteries configuring the secondary battery module; thus, the description is omitted.

FIG. 14E illustrates an artificial satellite 2005 including a secondary battery 2204 as an example. The artificial satellite 2005 is desired to develop no trouble due to ignition because the artificial satellite 2005 is used in a cosmic space; thus, the secondary battery 2204 which is a highly safe secondary battery of one embodiment of the present invention is preferably provided. It is further preferable that the secondary battery 2204 be mounted inside the artificial satellite 2005 while being covered with a heat-retaining member.

### Embodiment 7

This embodiment describes examples in which the lithium-ion battery of one embodiment of the present invention is mounted on a two-wheeled vehicle and a bicycle as examples of mounting a secondary battery in a vehicle.

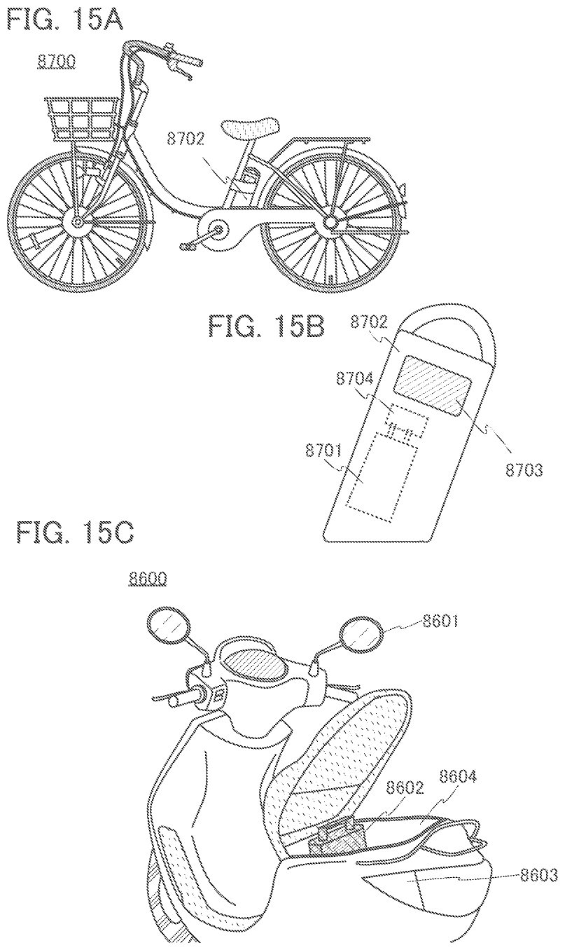

FIG. 15A illustrates an example of an electric bicycle using the power storage device of one embodiment of the present invention. The power storage device of one embodiment of the present invention can be used for an electric bicycle 8700 in FIG. 15A. The power storage device of one embodiment of the present invention includes a plurality of storage batteries and a protection circuit, for example.

The electric bicycle 8700 is provided with a power storage device 8702. The power storage device 8702 can supply electric power to a motor that assists a rider. The power storage device 8702 is portable, and FIG. 15B illustrates the state where the power storage device 8702 is removed from the electric bicycle. The power storage device 8702 incorporates a plurality of storage batteries 8701 included in the power storage device of one embodiment of the present invention, and can display the remaining battery level and the like on a display portion 8703. The power storage device 8702 includes a control circuit 8704 capable of charge control or anomaly detection for the secondary battery. The control circuit 8704 is electrically connected to a positive electrode and a negative electrode of the storage battery 8701. When the control circuit 8704 is used in combination with a secondary battery having a positive electrode using the positive electrode active material 100 obtained in Embodiments 1 to 3, the synergy on safety can be obtained. The secondary battery having the positive electrode using the positive electrode active material 100 obtained in Embodiments 1 to 3 and the control circuit 8704 have a high level of safety and thus can contribute greatly to elimination of accidents due to secondary batteries, such as fires.

FIG. 15C illustrates an example of a two-wheeled vehicle using the power storage device of one embodiment of the present invention. A motor scooter 8600 illustrated in FIG. 15C includes a power storage device 8602, side mirrors 8601, and indicators 8603. The power storage device 8602 can supply electric power to the indicators 8603. The power storage device 8602 including a plurality of secondary batteries having a positive electrode using the positive electrode active material 100 obtained in Embodiments 1 to 3 can have high capacity and contribute to a reduction in size.

In the motor scooter 8600 illustrated in FIG. 15C, the power storage device 8602 can be held in an under-seat storage unit 8604. The power storage device 8602 can be held in the under-seat storage unit 8604 even with a small size.

### Embodiment 8

In this embodiment, examples of electronic devices each including the secondary battery of one embodiment of the present invention are described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game console, a portable information terminal, an audio reproducing device, and a large-sized game machine such as a pachinko machine. Examples of the portable information terminal include a laptop personal computer, a tablet terminal, an e-book reader, and a mobile phone.

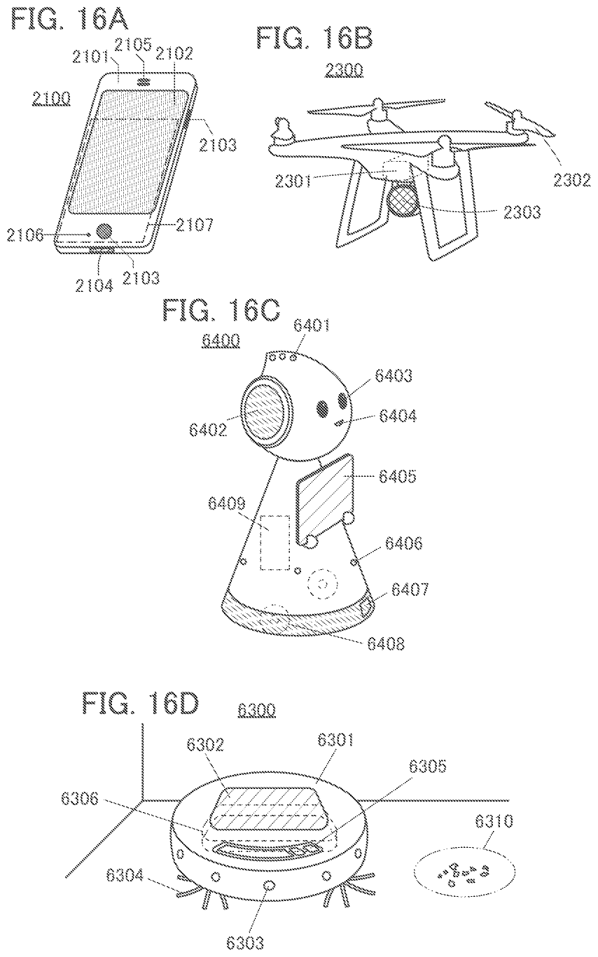

FIG. 16A illustrates an example of a mobile phone. A mobile phone 2100 includes a housing 2101 in which a display portion 2102 is incorporated, an operation button 2103, an external connection port 2104, a speaker 2105, a microphone 2106, and the like. The mobile phone 2100 includes a secondary battery 2107. The use of the secondary battery 2107 having a positive electrode using the positive electrode active material 100 described in Embodiments 1 to 3 achieves high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication based on an existing communication standard. For example, mutual communication between the mobile phone 2100 and a headset capable of wireless communication can be performed, and thus hands-free calling is possible.

Moreover, the mobile phone 2100 includes the external connection port 2104, and data can be directly transmitted to and received from another information terminal via a connector. In addition, charging can be performed via the external connection port 2104. Note that the charge operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 16B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material 100 obtained in Embodiments 1 to 3 has a high energy density and a high degree of safety, and thus can be used safely for a long time over a long period of time and is preferable as the secondary battery included in the unmanned aircraft 2300.

FIG. 16C illustrates an example of a robot. A robot 6400 illustrated in FIG. 16C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the positive electrode active material 100 obtained in Embodiments 1 to 3 has a high energy density and a high degree of safety, and thus can be used safely for a long time over along period of time and is preferable as the secondary battery 6409 included in the robot 6400.

FIG. 16D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

The cleaning robot 6300 can determine whether there is an obstacle such as a wall, furniture, or a step by analyzing images taken by the cameras 6303. In the case where the cleaning robot 6300 detects an object that is likely to be caught in the brush 6304 (e.g., a wire) by image analysis, the rotation of the brush 6304 can be stopped. The cleaning robot 6300 further includes, in its inner region, the secondary battery 6306 of one embodiment of the present invention and a semiconductor device or an electronic component. A secondary battery including a positive electrode using the positive electrode active material 100 obtained in Embodiments 1 to 3 has a high energy density and a high degree of safety, and thus can be used safely for a long time over along period of time and is preferable as the secondary battery 6306 included in the cleaning robot 6300.

### Embodiment 9

In this embodiment, thermal runaway, a nail penetration test, and the like of a secondary battery will be described to explain the principle or the like that ignition is less likely to occur when a secondary battery including one or more of the positive electrode active materials 100 and 101, each of which is one embodiment of the present invention, is subjected to a nail penetration test.

### <Thermal Runaway of Secondary Battery>

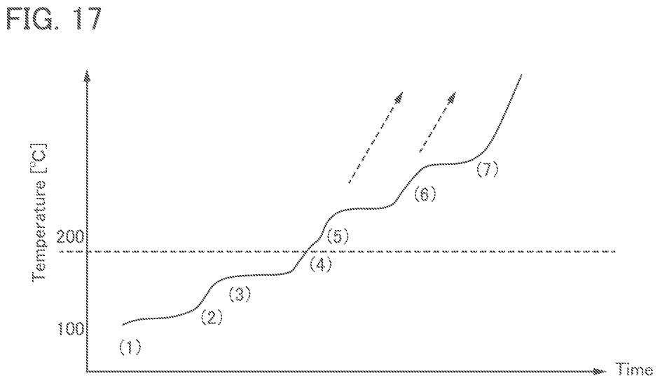

FIG. 17 is a graph obtained by partly modifying the graph cited from [FIG. 2-11] on p. 69 of Non-Patent Document 1. The graph in FIG. 17 shows the internal temperature of a secondary battery (hereinafter simply referred to as temperature) with respect to time. According to the graph, when the temperature rises, the secondary battery enters thermal runaway after passing through several states.

In general, when the temperature of the secondary battery reaches 100° C. or the vicinity thereof, (1) collapse of a solid electrolyte interphase (SEI) of a negative electrode and heat generation are caused. When the temperature of the secondary battery exceeds 100° C., (2) reduction of an electrolyte solution by the negative electrode (the negative electrode is C₆Li when graphite is used) and heat generation are caused, and (3) oxidation of the electrolyte solution by a positive electrode and heat generation are caused. When the temperature of the secondary battery reaches 180° C. or the vicinity thereof, (4) thermal decomposition of the electrolyte solution is caused and (5) oxygen release from the positive electrode and thermal decomposition of the positive electrode (the thermal decomposition includes a structural change in a positive electrode active material) are caused. After that, when the temperature of the secondary battery exceeds 200° C., (6) decomposition of the negative electrode is caused, and finally, (7) the positive electrode and the negative electrode come into direct contact with each other. The secondary battery enters thermal runaway after passing through the state (5), the state (6), the state (7), or the like. Thus, to prevent thermal runaway, the temperature increase of the secondary battery is preferably inhibited and the negative electrode, the positive electrode, and/or the electrolyte solution is/are preferably kept stable at high temperatures exceeding 100° C.

Each of the positive electrode active materials 100 and 101, which is one embodiment of the present invention described in Embodiments 1 to 3, has a stable crystal structure and inhibits release of oxygen advantageously. Thus, the secondary battery including the positive electrode active material 100 or 101 probably does not come into a state of after at least the state (5) and the temperature increase of the secondary battery is probably inhibited, leading to a significant effect that thermal runaway is less likely to occur.

### <Nail Penetration Test>

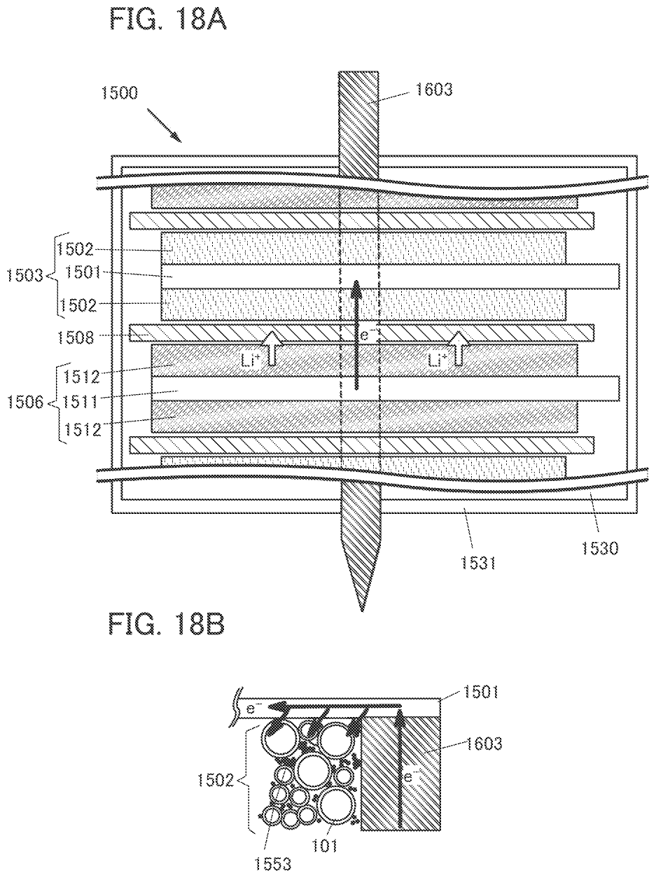

Next, the nail penetration test is described with reference to FIGS. 18A and 18B and the like. In the nail penetration test, a nail 1603 having a predetermined diameter selected from a range of 2 mm to 10 mm penetrates a secondary battery 1500 in a fully charged state (a state at 100% state of charge (SOC)) at a predetermined speed selected from a range of 1 mm/s to 20 mm/s, for example. FIG. 18A is a cross-sectional view illustrating the state where the nail 1603 penetrates the secondary battery 1500. The secondary battery 1500 has a structure in which a positive electrode 1503, a separator 1508, a negative electrode 1506, and an electrolyte solution 1530 are held in an exterior body 1531. The positive electrode 1503 includes a positive electrode current collector 1501 and positive electrode active material layers 1502 formed over both surfaces of the positive electrode current collector 1501. The negative electrode 1506 includes a negative electrode current collector 1511 and negative electrode active material layers 1512 formed over both surfaces of the negative electrode current collector 1511. FIG. 18B is an enlarged view illustrating the nail 1603 and the positive electrode current collector 1501. FIG. 18B clearly illustrates the positive electrode active material 101 described in Embodiment 1 and a conductive material 1553 included in the positive electrode active material layer 1502.

An internal short circuit generally occurs when the nail 1603 penetrates the positive electrode 1503 and the negative electrode 1506 as illustrated in FIGS. 18A and 18B. This makes the potential of the nail 1603 equivalent to the potential of the negative electrode, so that an electron (e⁻) flows to the positive electrode 1503 through the nail 1603 and the like as indicated by black arrows and Joule heat is generated in the portion where the internal short circuit has occurred and the vicinity of the portion. The internal short circuit causes carrier ions typified by lithium ions (Li⁺) to be extracted from the negative electrode 1506 and to be released into the electrolyte solution as indicated by white arrows. At this time, insufficient anions in the electrolyte solution 1530 causes the electrolyte solution 1530 to start decomposing because the electrolyte solution 1530 cannot receive all the lithium ions extracted from the negative electrode 1506. This is one of electrochemical reactions and is referred to as a reduction reaction of an electrolyte solution by a negative electrode. Then, the electron (e⁻) that has flowed to the positive electrode 1503 reduces cobalt, which is tetravalent in the lithium cobalt oxide (also referred to as LCO) in the charged state, so that the cobalt becomes trivalent or divalent. This reduction reaction causes oxygen release from the lithium cobalt oxide, and the electrolyte solution 1530 is decomposed by the released oxygen or the like. This is one of electrochemical reactions and is referred to as an oxidation reaction of an electrolyte solution by a positive electrode. The above reaction occurs similarly in the case of using NCM.

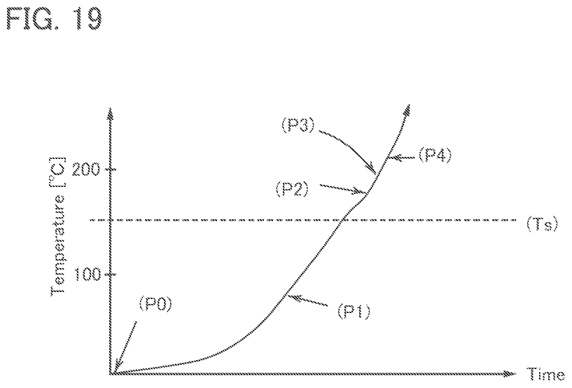

When an internal short circuit of a secondary battery occurs, its temperature generally changes as shown in the graph of FIG. 19. FIG. 19 is a graph obtained by partly modifying the graph cited from [FIG. 2-12] on p. 70 of Non-Patent Document 1. This graph shows the temperature of a secondary battery with respect to time. According to the graph, upon an internal short circuit at (P0), the temperature of the secondary battery increases over time. Specifically, when the temperature of the secondary battery reaches 100° C. or the vicinity thereof because of Joule heat as indicated by (P1), the temperature exceeds the reference temperature (Ts) of the secondary battery. Then, reduction of an electrolyte solution by a negative electrode (the negative electrode is C₆Li when graphite is used) and heat generation are caused at (P2), oxidation of the electrolyte solution by a positive electrode and heat generation are caused at (P3), and heat generation due to thermal decomposition of the electrolyte solution is caused at (P4). Accordingly, the secondary battery enters thermal runaway, resulting in ignition or the like.

When a nail penetration test is performed on the secondary battery including one or more of the positive electrode active materials 100 and 101, each of which is one embodiment of the present invention described in Embodiments 1 to 3, the speed of current flowing into the positive electrode in the case of an internal short-circuit is probably reduced because the positive electrode active materials 100 and 101 include the shell described above. In that case, a significant effect that thermal runaway is less likely to occur and thus ignition or the like is less likely to occur can be obtained.

### Embodiment 10

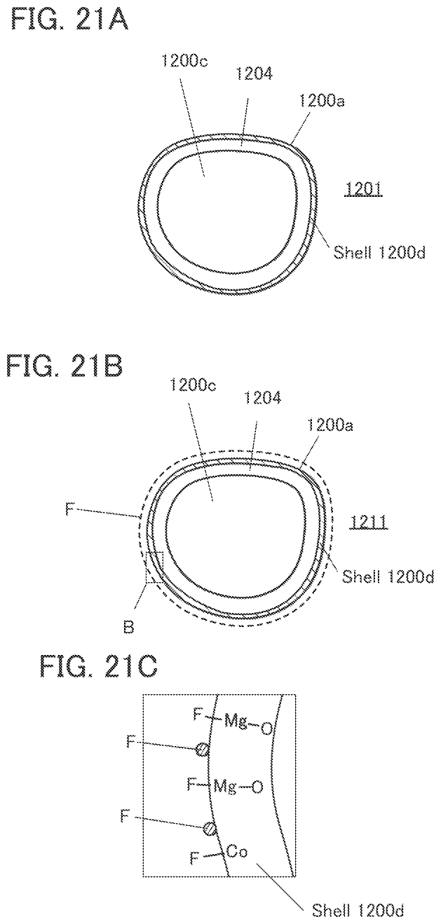

In this embodiment, a positive electrode active material 1201 of one embodiment of the present invention will be described with reference to FIG. 21A.

The positive electrode active material 1201 contains lithium, a transition metal M, and oxygen. The transition metal M is one or more selected from nickel, manganese, and cobalt. The positive electrode active material 1201 preferably contains an additive element in addition to the elements. The positive electrode active material 1201 can contain lithium nickel-manganese-cobalt oxide to which an additive element is added.

A positive electrode active material of a lithium-ion secondary battery needs to contain a transition metal which can take part in an oxidation-reduction reaction in order to maintain a neutrally charged state even when lithium ions are inserted and extracted. The positive electrode active material 1201 of one embodiment of the present invention contains nickel, manganese, and cobalt as the transition metal M taking part in an oxidation-reduction reaction.

Nickel preferably accounts for a large percentage of the transition metal M contained in the positive electrode active material 1201 because it is easier to increase the charge and discharge capacity than in the case where cobalt accounts for more than half, even when charge voltage is low. Thus, nickel preferably accounts for 50% or more of the transition metal M, further preferably 60% or more, still further preferably 75% or more, for example. The positive electrode active material 1201 contains fluorine, and a Ni—Co—Mn-based positive electrode active material (also referred to as NCM) whose composition excluding fluorine is represented by LiNiₓCo_{y}Mn_{z}O₂ (x>0, y>0, and z>0) is used as the positive electrode active material. Note that x, y, and z preferably satisfy x:y:z=5:2:3 or the neighborhood thereof, for example. Alternatively, for example, x, y, and z preferably satisfy x:y:z=8:1:1 or the neighborhood thereof. Alternatively, for example, x, y, and z preferably satisfy x:y:z=9:0.5:0.5 or the neighborhood thereof.

An additive element may be added to the positive electrode active material 1201. For example, one or more selected from magnesium, aluminum, calcium, titanium, zirconium, fluorine, vanadium, iron, manganese, chromium, niobium, arsenic, zinc, silicon, sulfur, phosphorus, boron, bromine, and beryllium may be used as the additive element. The ratio of the number of atoms of the additive element to the total number of atoms of the transition metal M (the transition metal M contains nickel, cobalt, and manganese) is preferably lower than 25 atomic %, further preferably lower than 10 atomic %, still further preferably lower than 5 atomic %.

Such an additive element further stabilizes the crystal structure of the positive electrode active material 1201 as described later.

A surface portion 1204 preferably has a higher fluorine concentration than an inner portion 1200c. The inner portion 1200c preferably has a higher nickel concentration than the surface portion. Note that LCO to which an additive element, e.g., magnesium, is added may be used for the surface portion 1204 so that the surface portion 1204 can function as a barrier film. In the case of using magnesium, a cobalt compound, magnesium fluoride, and NCM are mixed and heated so that NCM can be the inner portion 1200c and the concentrations of magnesium and fluorine in the surface portion 1204 can be higher than those in the inner portion 1200c. In the case of using magnesium as the additive element, the cobalt concentration in the surface portion 1204 can be higher than that in the inner portion 1200c because magnesium is compatible with cobalt.

When the surface portion 1204 formed using LCO contains magnesium, thermal safety can be improved. The surface portion 1204 further containing fluorine can inhibit overheating or ignition of the lithium-ion secondary battery and can further improve thermal safety.

### <Surface and Surface Portion>

FIG. 21A is a cross-sectional view of the positive electrode active material 1201 which is a single particle. The positive electrode active material 1201 preferably includes a shell 1200d, the surface portion 1204, and the inner portion 1200c.

The positive electrode active material 1201 of one embodiment of the present invention preferably has a region whose resistance can be increased. Such a region is referred to as a first region, in some cases, to be distinguished from other regions. The first region preferably has, in a cross-sectional view, a narrow width (short range) of greater than or equal to 2 nm and less than or equal to 20 nm, further preferably greater than or equal to 2 nm and less than or equal to 10 nm, still further preferably greater than or equal to 2 nm and less than or equal to 5 nm. Such a region having a narrow width is referred to as a “shell” in this specification and the like, in some cases. FIG. 21A illustrates an example in which the shell 1200d covers the surface portion 1204 of the particle. The positive electrode active material 1201 including such a shell 1200d is preferred because the speed of current flowing into the positive electrode active material can be reduced even when the secondary battery is subjected to a nail penetration test, which can inhibit ignition, smoke, or the like.

The shell 1200d preferably contains cobalt, in which case the shell 1200d allows insertion and extraction of lithium ions (Li⁺) and a reduction in speed of current that flows because of an internal short-circuit. The positive electrode active material 1201 preferably has the first region and a second region which is at a position deeper than the first region; magnesium is preferably contained at least in the first region, and the second region does not necessarily contain magnesium. Cobalt contained in the first region and the second region probably allows insertion and extraction of lithium ions (Li⁺).

When the positive electrode active material 1201 is subjected to EDX linear analysis, a peak of the magnesium concentration in the surface portion 1204 is preferably observed in a region that is 3 nm in depth, further preferably 1 nm in depth, still further preferably 0.5 nm in depth from the boundary between the shell and the surface portion of the positive electrode active material 1201 toward the center of the positive electrode active material 1201. In addition, the magnesium concentration preferably attenuates, at a depth of 1 nm from the point where the concentration reaches the peak, to less than or equal to 60% of the peak concentration. The magnesium concentration preferably attenuates, at a depth of 2 nm from the point where the concentration reaches the peak, to less than or equal to 30% of the peak concentration. Here, a “peak of concentration” refers to the local maximum value of concentration.

In the EDX linear analysis, the distribution of fluorine preferably overlaps with the distribution of magnesium in the surface portion 1204 of the positive electrode active material 1201. For example, a difference in the depth direction between a peak of the fluorine concentration and a peak of the magnesium concentration is preferably within 10 nm, further preferably within 3 nm, still further preferably within 1 nm.

In the EDX linear analysis, a peak of the nickel concentration in the surface portion 1204 is preferably observed in a region that is 3 nm in depth, further preferably 1 nm in depth, still further preferably 0.5 nm in depth from the boundary between the shell and the surface portion toward the center of the positive electrode active material 1201. When the surface portion 1204 contains magnesium and nickel, the distribution of nickel preferably overlaps with the distribution of magnesium. For example, a difference in the depth direction between a peak of the nickel concentration and a peak of the magnesium concentration is preferably within 10 nm, further preferably within 3 nm, still further preferably within 1 nm.

EDX linear, surface, or point analysis of the positive electrode active material 1201 preferably reveals that the atomic ratio of magnesium to cobalt (Mg/Co) at a peak of the magnesium concentration is preferably greater than or equal to 0.05 and less than or equal to 0.6, further preferably greater than or equal to 0.1 and less than or equal to 0.4. The atomic ratio of nickel to cobalt (Ni/Co) at a peak of the nickel concentration is preferably greater than or equal to 0 and less than or equal to 0.2, further preferably greater than or equal to 0.01 and less than or equal to 0.1. The atomic ratio of fluorine to cobalt (F/Co) at a peak of the fluorine concentration is preferably greater than or equal to 0 and less than or equal to 1.6, further preferably greater than or equal to 0.1 and less than or equal to 1.4.

FIG. 21B is a schematic cross-sectional view of a positive electrode active material 1211, and FIG. 21C is an enlarged conceptual diagram of the region B indicated by a rectangle in FIG. 21B. As illustrated in FIG. 21C, fluorine, which is an additive element, is preferably adsorbed on a surface 1200a of the positive electrode active material. Fluorine has high electronegativity and is likely to form stable compounds with many kinds of element. When the adsorbed fluorine is bonded to an element on the surface by a chemical reaction, the surface 1200a can be referred to as a surface having a fluoro group.

FIG. 21C illustrates a state where at least fluorine is adsorbed on the shell 1200d of the positive electrode active material 1201. Fluorine does not need to be inside the shell 1200d nor inside the surface portion 1204 as long as the adsorbed fluorine efficiently contributes to inhibition of overheating or ignition of the lithium-ion secondary battery and further improvement in thermal safety.

The shell 1200d or the adsorbed fluorine makes release of oxygen in the positive electrode active material 1201 difficult and can inhibit a thermal decomposition reaction. The use of the positive electrode active material 1201 including the shell 1200d for a positive electrode can inhibit overheating or ignition of the lithium-ion secondary battery and can improve thermal safety.

Note that adsorption may be chemical adsorption or physical adsorption. Chemical adsorption refers to formation of a chemical bond due to a chemical reaction between at least one of additive elements and the surface 1200a of the positive electrode active material, whereas physical adsorption refers to adsorption due to intermolecular force (van der Waals force) exerted between at least one of additive elements and the surface of the positive electrode active material 1201. As is described later, fluorine may be substituted for part of oxygen in the positive electrode active material 1201. Sufficient fluorine contained in the positive electrode active material 1201 means that there are fluorine adsorbed on the surface and fluorine substituted for part of oxygen.

Examples of a fluoride contained in the lithium-ion secondary battery include LiPF₆ and LiBF₄ as lithium salts and polyvinylidene fluoride (PVDF) as a binder. Fluorine originating from such a fluoride may be adsorbed on the surface 1200a of the positive electrode active material.

The surface portion 1204 of the positive electrode active material 1201 in FIG. 21A is, for example, a region within 50 nm, preferably 35 nm, and further preferably 20 nm in depth from the interface between the shell 1200d and the surface portion toward the inner portion, and is most preferably within 10 nm in depth, in a direction perpendicular or substantially perpendicular to the surface, from the interface between the shell 1200d and the surface portion toward the inner portion. Note that “substantially perpendicular” refers to a state where an angle is greater than or equal to 80° and less than or equal to 100°. A plane generated by a crack can be considered as the surface 1200a. The outline of the surface 1200a of the positive electrode active material 1201 can be seen when the cross section of the surface is observed. The surface portion 1204 can also be referred to as a barrier film, and can be rephrased as the vicinity of a surface, or a region in the vicinity of a surface.

FIG. 21A illustrates an example in which the shell 1200d is provided to have a uniform thickness; however, there is no particular limitation.

The inner portion 1200c refers to a region deeper than the surface portion 1204 of the positive electrode active material. The inner portion 1200c can be rephrased as an inner region or a core. The surface portion 1204 can be referred to as a first shell, and the shell 1200d can be referred to as a second shell. The inner portion 1200c contains NCM, which has a composition different from that of LCO contained in the surface portion 1204. Accordingly, there is a boundary between the inner portion 1200c and the surface portion 1204. Note that a clear boundary is not formed depending on heating conditions, in some cases.

The surface 1200a of the positive electrode active material refers to a surface of the shell 1200d. Thus, the positive electrode active material 1201 does not contain a material to which a metal oxide that does not contain a lithium site contributing to charging and discharging, such as aluminum oxide, is attached on the surface 1200a, or a carbonate, a hydroxy group, or the like which is chemically adsorbed after formation of the positive electrode active material. The attached metal oxide refers to, for example, a metal oxide having a crystal structure different from the crystal structures of the inner portion 1200c and the surface portion 1204.

Since the positive electrode active material 1201 is a compound containing oxygen and a transition metal into and from which lithium ions can be inserted and extracted, an interface between a region where oxygen and the transition metal M (Co, Ni, Mn, Fe, or the like) that is oxidized or reduced due to insertion and extraction of lithium ions exist and a region where oxygen and the transition metal M do not exist is considered as the surface 1200a of the positive electrode active material. When the positive electrode active material is analyzed, a protective film is attached on its surface in some cases; however, the protective film is not included in the positive electrode active material. As the protective film, a single-layer film or a multilayer film of carbon, a metal, an oxide, a resin, or the like is sometimes used.

This embodiment can be implemented in combination with any of the other embodiments.

### Embodiment 11

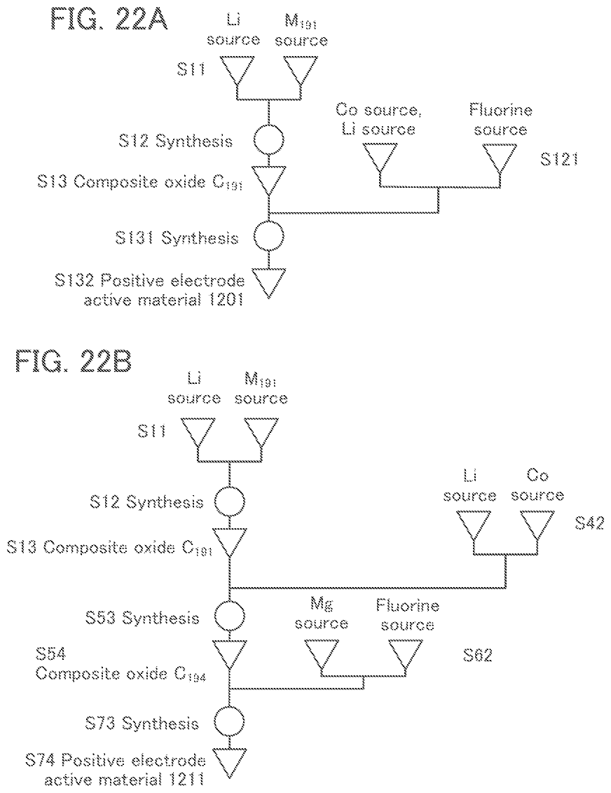

In this embodiment, an example of a formation method of the positive electrode active material 1201 described in Embodiment 10 will be described with reference to FIG. 22A.

First, in Step S11, a lithium source and a transition metal M₁₉₁ source for the inner portion 1200c of the positive electrode active material 1201 are prepared. The transition metal M₁₉₁ source contains nickel, manganese, and cobalt.

Next, in Step S12, synthesis is performed using the lithium source and the transition metal M₁₉₁ source for the inner portion 1200c of the positive electrode active material 1201. The synthesis can be performed by, for example, a method in which the lithium source and the transition metal source for the inner portion 1200c of the positive electrode active material 1201 are mixed by a solid phase method and then heating is performed.

In this manner, the composite oxide C₁₉₁ contained in the inner portion 1200c of the positive electrode active material 1201 is formed (Step S13). Although an example in which the composite oxide C₁₉₁ is synthesized is described in this embodiment, a commercially available product equivalent to the composite oxide C₁₉₁ may be used.

Next, in Step S121, a fluorine source, and a cobalt source and a lithium source for the surface portion 1204 of the positive electrode active material 1201 are prepared. As the cobalt source, the lithium source, and the fluorine source, cobalt fluoride, lithium fluoride (LiF), and magnesium fluoride can be used, respectively. Note that LiF is preferable because it is easily melted in an annealing process described later owing to its relatively low melting point of 848° C. The use of magnesium fluoride allows magnesium to be placed in the vicinity of the surface of the positive electrode active material at high concentration.

Then, in Step S131, synthesis is performed using the fluorine source, the composite oxide C₁₉₁ contained in the inner portion 1200c of the positive electrode active material 1201, and the cobalt source and the lithium source for the surface portion 1204 of the positive electrode active material 1201. As a result, NCM serves as the inner portion 1200c of the positive electrode active material 1201, and the inner portion 1200c is covered with the surface portion 1204. The surface portion 1204 is a barrier film containing at least cobalt, magnesium, and lithium, and has a layered rock-salt crystal structure. The synthesis can be performed by a method in which the fluorine source, the composite oxide C₁₉₁, the cobalt source, and the lithium source are mixed by a solid phase method and then heating is performed. A sol-gel method may also be used for the synthesis.

Since the annealing method in Step S131 is the same as that in Step S31 in Embodiment 1, the description thereof is omitted here.

The annealing in Step S131 is preferably performed at an appropriate temperature for an appropriate time. When the annealing temperature is too high, the materials are melted and mixed, so that the positive electrode active material 1201 having a barrier layer cannot be obtained. The time for lowering the temperature after the annealing is preferably longer than or equal to 10 hours and shorter than or equal to 50 hours, for example. Then, the material subjected to the annealing is collected, whereby the positive electrode active material 1201 is obtained.

In this manner, the positive electrode active material 1201 illustrated in FIG. 21A is formed (Step S132). The surface 1200a may be in contact with a solution containing fluorine after Step S131 so that fluorine is adsorbed on the surface 1200a. In that case, fluorine or a fluoride can be adsorbed on the surface 1200a.

In the case of adding fluorine at high concentration, the surface 1200a may be in contact with a solution containing fluorine a plurality of times.

A positive electrode active material 1211 illustrated in FIG. 21B can be formed through a flowchart shown in FIG. 22B, for example.

First, in Step S11, a lithium source and a transition metal M₁₉₁ source for the inner portion 1200c are prepared.

Next, in Step S12, synthesis is performed using the lithium source and the transition metal M₁₉₁ source for the inner portion 1200c of the positive electrode active material 1211. The synthesis can be performed by, for example, a method in which the lithium source and the transition metal source for the inner portion 1200c of the positive electrode active material 1211 are mixed by a solid phase method and then heating is performed.

In this manner, the composite oxide C₁₉₁ contained in the inner portion 1200c of the positive electrode active material 1211 is formed (Step S13). Although an example in which the composite oxide C₁₉₁ is synthesized is described in this embodiment, a commercially available product equivalent to the composite oxide C₁₉₁ may be used.

Next, in Step S42, a lithium source and a cobalt source for the surface portion 1204 are prepared.

Then, in Step S53, synthesis is performed using the composite oxide C₁₉₁ contained in the inner portion 1200c of the positive electrode active material 1211, the lithium source, and the cobalt source. The synthesis can be performed by a method in which the composite oxide C₁₉₁, the lithium source, and the cobalt source are mixed by a solid phase method and then heating is performed.

In this manner, a composite oxide C₁₉₄ including the inner portion 1200c covered with the surface portion 1204 is formed. At this stage, a particle in which a surface of the inner portion 1200c of the positive electrode active material 1211, i.e., a surface of NCM, is covered with lithium cobalt oxide (LCO) can be obtained (Step S54).

Next, in Step S62, a magnesium source for the surface portion 1204 and a fluorine source used for making fluorine adsorbed on a surface of the composite oxide C₁₉₄ are prepared.

After that, in Step S73, synthesis is performed using the composite oxide C₁₉₄, the magnesium source for the surface portion 1204, and the fluorine source. As a result of this synthesis, the surface portion 1204, which is formed of lithium cobalt oxide (LCO), is doped with magnesium or fluorine. The synthesis can be performed by a method in which the composite oxide C₁₉₄, the magnesium source, and the fluorine source are mixed by a solid phase method and then heating is performed. A sol-gel method may also be used for the synthesis.

In this manner, the positive electrode active material 1211 illustrated in FIG. 21C is formed (Step S74). The surface 1200a may be in contact with a solution containing fluorine after Step S73 so that fluorine is adsorbed on the surface 1200a. In that case, fluorine or a fluoride can be adsorbed on the surface 1200a.

This embodiment can be implemented in combination with any of the other embodiments.

### Embodiment 12

Although an example in which the inner portion 1200c and the surface portion 1204 of the positive electrode active material 1201 are formed using a solid phase method is described in Embodiment 11, the inner portion 1200c of the positive electrode active material 1201 can be formed using a coprecipitation method.

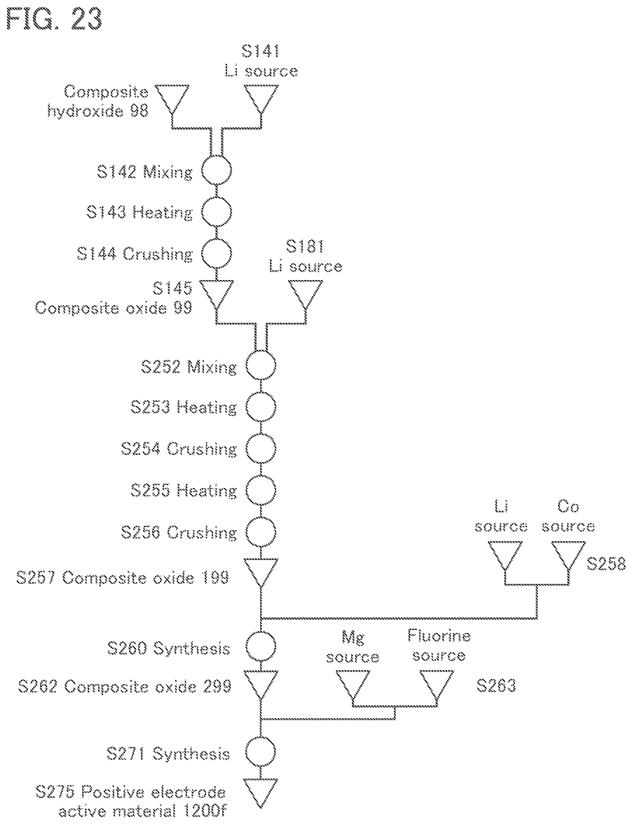

In this embodiment, an example of a formation method of a positive electrode active material 1200f of one embodiment of the present invention will be described with reference to FIG. 4, FIG. 5, and FIG. 23. The formation method up to the step of obtaining the composite oxide 99 is the same as that of the positive electrode active material 100 in Embodiment 3; thus, the detailed description thereof is omitted here.

According to Embodiment 3, in Step S111 in FIG. 4, first, a transition metal M source including a nickel source (Ni source), a cobalt source (Co source), and a manganese source (Mn source) is prepared.

Next, as shown in Step S113 in FIG. 4, a chelate agent is prepared.

Then, in Step S114 in FIG. 4, the transition metal M source and the chelate agent are mixed, so that an acid solution is formed.

Subsequently, in Step S121 in FIG. 4, an alkaline solution is prepared.

After that, as shown in Step S122 in FIG. 4, water is prepared in a reaction vessel.

Next, in Step S131 in FIG. 4, an acid solution and an alkaline solution are mixed to be reacted with each other. The reaction can be referred to as a coprecipitation reaction, a neutralization reaction, or an acid-base reaction.

During the coprecipitation reaction of Step S131, the pH of the reaction system is preferably higher than or equal to 9.0 and lower than or equal to 11.5.

Through above-described coprecipitation reaction, the composite hydroxide 98 containing the transition metal M is precipitated.

Then, filtration is preferably performed to collect the composite hydroxide 98 as in Step S132 in FIG. 4.

Next, as shown in Step S133 in FIG. 4, the composite hydroxide 98 after the filtration is preferably dried.

In this manner, the composite hydroxide 98 containing the transition metal M can be obtained.

Next, as in Embodiment 3, a lithium source is prepared in Step S141 in FIG. 23. Note that Step S141 in FIG. 23 is the same as Step S141 in FIG. 5. Since a process of adding a lithium source and performing heating is performed a plurality of times at this time, the amount of lithium prepared in Step S141 is smaller than the final required amount of lithium. For example, the atomic ratio of lithium to the total of nickel, cobalt, and manganese can be, when the total is 1, greater than or equal to 0.5 and less than or equal to 0.9, and is preferably 0.7.

After that in Step S142 in FIG. 23, the composite hydroxide 98 and the lithium source are mixed. Note that Step S142 in FIG. 23 is the same as Step S142 in FIG. 5.

Then, heating is performed on the mixture of the composite hydroxide 98 and the lithium source (Step S143). The heating in Step S143, heating in Step S253, and heating in Step S255 in FIG. 23 may be sometimes referred to as first heating, second heating, and third heating, respectively, so as to be distinguished from one another.

An electric furnace or a rotary kiln furnace can be used as a firing device for the heating. A crucible, a sagger, a setter, or a container used in the heating is preferably made of a material that hardly releases impurities. For example, a crucible made of aluminum oxide with a purity of 99.9% can be used. In the case of mass production, a sagger made of mullite cordierite (Al₂O₃·SiO₂·MgO) can be used, for example. Such a container is preferably heated with the lid on.

The heating in Step S143 is preferably performed at a temperature higher than or equal to 400° C. and lower than or equal to 750° C., further preferably higher than or equal to 650° C. and lower than or equal to 750° C. The time for the heating in Step S143 is preferably longer than or equal to 1 hour and shorter than or equal to 30 hours, further preferably longer than or equal to 2 hours and shorter than or equal to 20 hours.

The heating atmosphere is preferably an oxygen atmosphere or an oxygen-containing atmosphere that is dry air with few moisture (e.g., with a dew point lower than or equal to −50° C., preferably lower than or equal to −80° C.).

Next, crushing is preferably performed in Step S144 after the heating. Through the above steps, the composite oxide 99 is obtained in Step S145. The composite oxide 99 is a material that can be called NCM.

### <Step S181>

Next, in Step S181, a lithium source is prepared. As the lithium source, lithium fluoride is used. In the case of using lithium fluoride, the amount of lithium in Step S181 is adjusted such that the total amount of lithium prepared in Step S181 and Step S141 becomes the final required amount of lithium.

### <Step S252>

Then, the composite oxide 99 obtained in Step S145 and the lithium source (lithium fluoride) are mixed.

### <Step S253>

Subsequently, heating is performed on the mixture of the composite oxide 99 and the fluorine source. The heating in Step S253 is preferably performed at sufficiently high temperatures to increase the crystallite size of the positive electrode active material 1200f. The temperature range may depend on the composition of the transition metal M.

In the case where the proportion of nickel in the transition metal M is high, e.g., higher than or equal to 70%, the heating temperature is preferably higher than or equal to 750° C., further preferably higher than or equal to 800° C., still further preferably higher than or equal to 850° C., for example. However, too high temperatures might cause reduction of the transition metal M including nickel to the divalent state, for example. Accordingly, the heating temperature is preferably lower than or equal to 950° C., further preferably lower than or equal to 920° C., still further preferably lower than or equal to 900° C., for example.

In the case where the proportion of nickel in the transition metal M is higher than or equal to 40% and lower than or equal to 60%, the heating temperature is preferably higher than or equal to 900° C., further preferably higher than or equal to 950° C., still further preferably around 970° C., for example. However, too high temperatures might cause the above disadvantage; accordingly, the heating temperature is preferably lower than or equal to 1020° C., further preferably lower than or equal to 990° C. For the other conditions of the heating, the description of Step S143 can be referred to.

Furthermore, crushing is preferably performed in Step S254 after the heating. The description of Step S144 can be referred to for the crushing.

### <Step S255>

In addition, the heating in Step S255 is preferably performed. The heating can reduce the residue of the lithium source or the like. The heating in Step S255 is preferably performed at a temperature higher than or equal to 400° C. and lower than or equal to 900° C., further preferably higher than or equal to 750° C. and lower than or equal to 850° C. The time for the heating in Step S255 is preferably longer than or equal to 1 hour and shorter than or equal to 30 hours, further preferably longer than or equal to 2 hours and shorter than or equal to 20 hours. Note that the heating in Step S255 is not necessarily performed.

Furthermore, crushing is preferably performed in Step S256 after the heating. The description of Step S144 can be referred to for the crushing. After the crushing, the resultant material is collected.

Through the above steps, a composite oxide 199 is obtained in Step S257. The composite oxide 199 is a material that can be called NCM.

### <Step S258>

Subsequently, a lithium source and a cobalt source are prepared.

Next, in Step S260, synthesis is performed using the composite oxide 199, the lithium source, and the cobalt source. The synthesis in Step S260 can be performed by a method in which the composite oxide 199, the lithium source, and the cobalt source are mixed by a solid phase method and then heating is performed.

In this manner, a composite oxide 299 including an inner portion (the composite oxide 199) covered with a surface portion is formed (Step S262). At this stage, a particle in which the inner portion, i.e., NCM, of the positive electrode active material 1200f is covered with lithium cobalt oxide (LCO) can be obtained.

Next, in Step S263, a magnesium source and a fluorine source used for making fluorine adsorbed on a surface of the composite oxide 299 are prepared.

After that, in Step S271, synthesis is performed using the composite oxide 299, the magnesium source, and the fluorine source. As a result of this synthesis, the surface portion, which is formed of lithium cobalt oxide (LCO), is doped with magnesium or fluorine. The synthesis can be performed by a method in which the composite oxide 299, the magnesium source, and the fluorine source are mixed by a solid phase method and then heating is performed. A sol-gel method may also be used for the synthesis.

Through the above steps, the positive electrode active material 1200f can be formed (Step S275). Note that the steps after Step S257 are the same as the steps after Step S12 described in Embodiment 2 and thus are briefly described here. The steps after Step S121 in FIG. 22A may be performed instead of the steps after Step S257 to reduce the number of steps.

This embodiment can be freely combined with any of the other embodiments.

### Embodiment 13

An example of a positive electrode formed for fabricating a secondary battery using the positive electrode active material 1201, 1211, or 1200f described in any one of Embodiments 10 to 12 is described below. The secondary battery at least includes an exterior body, a current collector, an active material (a positive electrode active material or a negative electrode active material), a conductive material, and a binder. The secondary battery also includes an electrolyte solution in which a lithium salt or the like is dissolved. In the secondary battery including an electrolyte solution, a positive electrode, a negative electrode, and a separator between the positive electrode and the negative electrode are provided. The electrolyte solution preferably contains a material having a fluoro group, in which case fluorine can be adsorbed on the surface of the positive electrode active material 1201, 1211, or 1200f. When the electrolyte solution contains a material having a fluoro group, fluorine can be adsorbed on the surface of the positive electrode active material 1201, 1211, or 1200f stably.

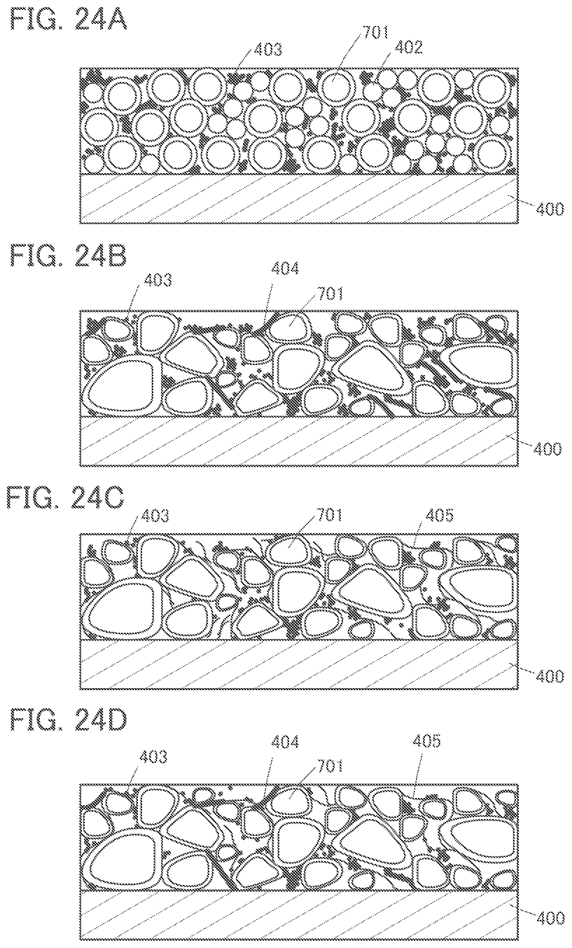

First, the positive electrode is described. FIG. 24A illustrates an example of a schematic cross-sectional view of the positive electrode. Since the positive electrode in FIG. 24A is the same as that in FIG. 6A except for the active material, the same portions are denoted by the same reference numerals and detailed descriptions thereof are omitted.

The current collector 400 is metal foil, and the positive electrode is formed by applying slurry onto the metal foil and drying the slurry. Pressing may be performed after drying. The positive electrode is a component obtained by forming an active material layer over the current collector 400.

In FIG. 24A, the acetylene black 403 is illustrated as a conductive material. FIG. 24A illustrates an example in which the second active material 402 with a smaller particle diameter than the positive electrode active material 1201, 1211, or 1200f described in any one of Embodiments 10 to 12 is mixed. The positive electrode including particles with different particle sizes can have high density.

In the positive electrode of the secondary battery, a binder (a resin) is mixed in order to fix the current collector 400 such as metal foil and the active material. The binder is also referred to as a binding agent. Since the binder is a high molecular material, a large amount of binder lowers the proportion of the active material in the positive electrode, thereby reducing the discharge capacity of the secondary battery. Therefore, the amount of binder mixed is reduced to a minimum. In FIG. 24A, a region not filled with any of an active material 701, the second active material 402, and the acetylene black 403 indicates a space or a binder.

In FIG. 24A, a boundary between an inner portion and a surface portion of the active material 701 is indicated by a solid line. Note that a shell corresponding to the outer shell of the surface portion of the active material 701 is not illustrated in FIG. 24A because the shell is thin. The active material 701 in FIG. 24A has a substantially circular cross-sectional shape, for example, which corresponds to the positive electrode active material 1201 in FIG. 21A. The surface portion contains magnesium at a higher concentration than the inner portion; thus, overheating or ignition of a lithium-ion secondary battery can be inhibited and thermal safety can be improved.

Although FIG. 24A illustrates an example in which the active material 701 has a spherical shape, there is no particular limitation and other various shapes can be employed. The cross-sectional shape of the active material 701 may be an ellipse, a rectangle, a trapezoid, a pyramid, a quadrilateral with rounded corners, or an asymmetrical shape.

FIG. 24B illustrates an example different from that in FIG. 24A. The active material 701 in FIG. 24B has an irregular shape, for example. In FIG. 24B, a boundary between the inner portion and the surface portion of the active material 701 is indicated by a solid line. Note that a shell corresponding to the outer shell of the surface portion of the active material 701 is not illustrated in FIG. 24B because the shell is thin. The surface portion of the active material 701 contains magnesium at a higher concentration than the inner portion; thus, overheating or ignition of a lithium-ion secondary battery can be inhibited and thermal safety can be improved.

In the positive electrode in FIG. 24B, the graphene 404 is used as a carbon material used as the conductive material.

In FIG. 24B, a positive electrode active material layer containing the active material 701, the graphene 404, and the acetylene black 403 is formed over the current collector 400. The graphene 404 is formed to partly coat or adhere to the surfaces of the plurality of particles of the active material 701, so that the graphene 404 makes surface contact with the particles of the active material 701. Note that the graphene 404 preferably clings to at least part of the active material 701. The graphene 404 preferably overlays at least part of the active material 701. The shape of the graphene 404 preferably conforms to at least part of the shape of the active material 701. The shape of the active material means, for example, an uneven surface of a single active material particle or an uneven surface formed by a plurality of active material particles. The graphene 404 preferably surrounds at least part of the active material 701. The graphene 404 may have a hole.

In the step of mixing the graphene 404 and the acetylene black 403 to obtain an electrode slurry, the weight of mixed acetylene black is preferably 1.5 to 20 times, further preferably 2 to 9.5 times the weight of graphene.

When the graphene 404 and the acetylene black 403 are mixed in the above ratio range, the acetylene black 403 can be dispersed uniformly and less likely to be aggregated at the time of preparing the slurry. Furthermore, when the graphene 404 and the acetylene black 403 are mixed in the above ratio range, the positive electrode can have a higher density than that using only the acetylene black 403 as the conductive material. As the electrode density is higher, the capacity per unit volume can be higher. Specifically, the density of the positive electrode active material layer measured by gravimetry can be higher than 3.5 g/cc. In addition, it is preferable that one or more of the positive electrode active materials 1201, 1211, and 1200f described in Embodiments 10 to 12 be used as the active material 701 of the positive electrode and the graphene 404 and the acetylene black 403 be mixed in the above ratio range, in which case synergy for higher capacity of the secondary battery can be expected.

A positive electrode containing a first carbon material (graphene) and a second carbon material (acetylene black) which are mixed in the above range enables fast charging, although having lower electrode density than a positive electrode containing only graphene as a conductive material. In addition, it is preferable that one or more of the positive electrode active materials 1201, 1211, and 1200f described in Embodiments 10 to 12 be used as the active material 701 of the positive electrode and the graphene 404 and the acetylene black 403 be mixed in the above ratio range, in which case synergy for higher stability and compatibility with faster charging of the secondary battery can be expected.

The above features are advantageous for secondary batteries for vehicles.

When a vehicle becomes heavier with increasing number of secondary batteries, more energy is consumed to move the vehicle, which decreases the mileage. With the use of high-density secondary batteries, the mileage of the vehicle can be maintained with almost no increase in the total weight of a vehicle including a secondary battery having the same weight.

Since power is needed to charge the secondary battery with higher capacity in the vehicle, the charging is desirably finished in a short time. What is called a regenerative charging, in which electric power temporarily generated when the vehicle is braked is used for charging, is performed under high rate charging conditions; thus, a secondary battery for a vehicle is desired to have favorable rate characteristics.

Using one of more of the positive electrode active materials 1201, 1211, and 1200f described in Embodiments 10 to 12 as the active material 701 of the positive electrode and mixing acetylene black and graphene within an optimal range enable both higher electrode density and formation of an appropriate space needed for ion conduction, whereby a secondary battery for a vehicle which has high energy density and favorable output characteristics can be obtained.

This structure is also effective in a portable information terminal, and using one of more of the positive electrode active materials 1201, 1211, and 1200f described in Embodiments 10 to 12 as the active material 701 of the positive electrode and setting the mixing ratio of acetylene black to graphene in the optimal range enable a small secondary battery with high capacity. Setting the mixing ratio of acetylene black to graphene in the optimal range also enables fast charging of a portable information terminal.

In FIG. 24B, the boundary between the inner portion and the surface portion of the active material 701 is indicated by a solid line in the active material 701. In FIG. 24B, a region not filled with any of the active material 701, the graphene 404, and the acetylene black 403 indicates a space or a binder. A space is required for the electrolyte solution to penetrate the positive electrode; too many spaces lower the electrode density, too few spaces do not allow the electrolyte solution to penetrate the positive electrode, and a space that remains after the secondary battery is completed lowers the efficiency.

Using one of more of the positive electrode active materials 1201, 1211, and 1200f described in Embodiments 10 to 12 as the active material 701 of the positive electrode and mixing acetylene black and graphene within an optimal range enable both higher electrode density and formation of an appropriate space needed for ion conduction, whereby a secondary battery which has high energy density and favorable output characteristics can be obtained.

FIG. 24C illustrates an example of a positive electrode in which a carbon nanotube 405, which is an example of fiber shaped carbon, is used instead of graphene. FIG. 24C illustrates an example different from that in FIG. 24B. The use of the carbon nanotube 405 can prevent aggregation of carbon black such as the acetylene black 403 and can increase the dispersibility.

A fluorine-containing carbon nanotube may be used. A fluorine-containing carbon nanotube can be formed by making a carbon nanotube and a fluorine compound contact each other (which is called fluorination treatment). The description of the fluorination treatment using graphene can be referred to for the fluorination treatment using carbon nanotube.

In FIG. 24C, a region not filled with any of the active material 701, the carbon nanotube 405, and the acetylene black 403 indicates a space or a binder.

FIG. 24D illustrates another example of a positive electrode. FIG. 24C illustrates an example in which the carbon nanotube 405 is used in addition to the graphene 404. The use of both the graphene 404 and the carbon nanotube 405 can prevent aggregation of carbon black such as the acetylene black 403 and can further increase the dispersibility.

Fluorine-containing acetylene black may be used. Fluorine-containing acetylene black can be formed by making acetylene black and a fluorine compound contact each other (which is called fluorination treatment). The description of the fluorination treatment using graphene can be referred to for the fluorination treatment using acetylene black.

In FIG. 24D, regions not filled with any of the active material 701, the carbon nanotube 405, the graphene 404, and the acetylene black 403 indicate spaces or binders.

A secondary battery can be fabricated by using any one of the positive electrodes in FIGS. 24A to 24D; setting, in a container (e.g., an exterior body or a metal can), a stack in which a separator is provided over the positive electrode and a negative electrode is provided over the separator; and filling the container with an electrolyte solution.

Although the above structure is an example of a secondary battery using an electrolyte solution, one embodiment of the present invention is not limited thereto.

For example, a semi-solid-state battery can be fabricated using one or more of the positive electrode active materials 1201, 1211, and 1200f described in Embodiments 10 to 12 as an active material of the positive electrode.

A semi-solid-state battery fabricated using one of more of the positive electrode active materials 1201, 1211, and 1200f described in Embodiments 10 to 12 is a secondary battery having high charge and discharge capacity. The semi-solid-state battery can have high charging and discharging voltages. Alternatively, a highly safe or highly reliable semi-solid-state battery can be achieved.

This embodiment can be freely combined with any of the other embodiments.

This application is based on Japanese Patent Application Serial No. 2022-092766 filed with Japan Patent Office on Jun. 8, 2022, Japanese Patent Application Serial No. 2022-098104 filed with Japan Patent Office on Jun. 17, 2022, and Japanese Patent Application Serial No. 2022-139989 filed with Japan Patent Office on Sep. 2, 2022, the entire contents of which are hereby incorporated by reference.

What is claimed is:

1. A positive electrode active material comprising nickel, manganese, cobalt, and oxygen,
wherein the positive electrode active material comprises a surface portion and an inner portion, and
wherein a magnesium concentration of the surface portion is higher than a magnesium concentration of the inner portion.

2. The positive electrode active material according to claim 1, wherein a surface of the surface portion comprises adsorbed fluorine.

3. A positive electrode active material comprising a transition metal M, oxygen, and fluorine,
wherein the transition metal M comprises nickel, manganese, and cobalt,
wherein the positive electrode active material comprises a surface portion and an inner portion,
wherein a surface of the surface portion comprises adsorbed fluorine, and
wherein a magnesium concentration of the surface portion is higher than a magnesium concentration of the inner portion.

4. A secondary battery comprising:
a positive electrode;
a negative electrode;
a separator between the positive electrode and the negative electrode; and
one or both of an ionic liquid and an organic solvent between the positive electrode and the negative electrode,
wherein the positive electrode comprises a positive electrode active material and a conductive material,
wherein the positive electrode active material comprises a transition metal M, oxygen, and fluorine,
wherein the transition metal M comprises nickel, manganese, and cobalt,
wherein the positive electrode active material comprises a surface portion and an inner portion,
wherein a magnesium concentration of the surface portion is higher than a magnesium concentration of the inner portion, and
wherein a surface of the surface portion comprises adsorbed fluorine.

5. The secondary battery according to claim 4, wherein fluorine is adsorbed on a surface of the conductive material.

6. The secondary battery according to claim 4, wherein the conductive material is a carbon nanotube.

7. The secondary battery according to claim 4, wherein the conductive material is acetylene black.
